(19) United States
(12) Patent Application Publication
(10) Pub. No.: US 2024/0241349 A1
(43) Pub. Date: Jul. 18, 2024

(54) IMAGING OPTICAL SYSTEM, AND IMAGE CAPTURE DEVICE INCLUDING THE SAME

(71) Applicant: Panasonic Intellectual Property Management Co., Ltd., Osaka (JP)

(72) Inventors: Takehiro NISHIOKA, Nara (JP); Yoshiaki KURIOKA, Osaka (JP)

(21) Appl. No.: 18/242,171

(22) Filed: Sep. 5, 2023

(30) Foreign Application Priority Data
Sep. 8, 2022 (JP) 2022-142614

(51) Int. Cl. G02B 13/00; G02B 9/64; G02B 27/64

(52) U.S. Cl. CPC G02B 13/0045; G02B 9/64; G02B 27/646

(57) ABSTRACT

An imaging optical system consists of a first lens group having positive power, an aperture stop, a second lens group having positive power, a third lens group having negative power, a fourth lens group having positive power, and a fifth lens group having negative power. The first lens group, the aperture stop, and the second, third, fourth, and fifth lens groups are arranged in this order such that the first lens group is located closer to an object than the aperture stop or the second, third, fourth, or fifth lens group is. While the imaging optical system is focusing to make a transition from an infinity in-focus state toward a close-object in-focus state, the first, third, and fifth lens groups are located at respectively fixed distances from an image plane in a direction aligned with an optical axis, and the second and fourth lens groups move along the optical axis.

### CROSS-REFERENCE TO RELATED APPLICATIONS

The present application is based on, and claims the benefit of foreign priority to, Japanese Patent Application No. 2022-142614, filed on Sep. 8, 2022, the entire disclosures of which are hereby incorporated by reference.

### TECHNICAL FIELD

The present disclosure relates to an imaging optical system having the ability to compensate for various types of aberrations sufficiently and an image capture device including such an imaging optical system.

### BACKGROUND ART

JP 2019-191502 A discloses an inner focus imaging lens including: a first lens group having positive power: a second lens group having positive power: a third lens group having negative power: a fourth lens group having positive power; and a fifth lens group having negative power. The first, second, third, fourth, and fifth lens groups are arranged in this order such that the first lens group is located closer to an object than any other lens group of this imaging optical system and that the fifth lens group is located closer to an image plane than any other lens group of this imaging optical system.

### SUMMARY

The present disclosure provides an imaging optical system having the ability to compensate for various types of aberrations sufficiently over the entire focus range and an image capture device including such an imaging optical system.

An imaging optical system according to an aspect of the present disclosure consists of a first lens group having positive power, an aperture stop, a second lens group having positive power, a third lens group having negative power, a fourth lens group having positive power, and a fifth lens group having negative power. The first lens group, the aperture stop, the second lens group, the third lens group, the fourth lens group, and the fifth lens group are arranged in this order such that the first lens group is located closer to an object than the aperture stop, the second lens group, the third lens group, the fourth lens group, or the fifth lens group is. While the imaging optical system is focusing to make a transition from an infinity in-focus state toward a close-object in-focus state, the first lens group, the third lens group, and the fifth lens group are located at respectively fixed distances from an image plane in a direction aligned with an optical axis, and the second lens group and the fourth lens group move along the optical axis.

An image capture device according to another aspect of the present disclosure has the ability to output an optical image of an object as an electrical image signal. The image capture device includes an imaging optical system that forms the optical image of the object and an image sensor that transforms the optical image formed by the imaging optical system into the electrical image signal. The imaging optical system consists of a first lens group having positive power, an aperture stop, a second lens group having positive power, a third lens group having negative power, a fourth lens group having positive power, and a fifth lens group having negative power. The first lens group, the aperture stop, the second lens group, the third lens group, the fourth lens group, and the fifth lens group are arranged in this order such that the first lens group is located closer to the object than the aperture stop, the second lens group, the third lens group, the fourth lens group, or the fifth lens group is. While the imaging optical system is focusing to make a transition from an infinity in-focus state toward a close-object in-focus state, the first lens group, the third lens group, and the fifth lens group are located at respectively fixed distances from an image plane in a direction aligned with an optical axis, and the second lens group and the fourth lens group move along the optical axis.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1A illustrates a lens arrangement diagram showing an infinity in-focus state of an imaging optical system according to a first embodiment (corresponding to a first example of numerical values):

FIG. 1B illustrates longitudinal aberration diagrams showing what state the imaging optical system assumes at respective focus positions in the first example of numerical values:

FIG. 1C illustrates lateral aberration diagrams showing a basic state and an image blur compensated state where the imaging optical system in the infinity in-focus state is making no image blur compensation, and making image blur compensation, respectively, in the first example of numerical values:

FIG. 2A illustrates a lens arrangement diagram showing an infinity in-focus state of an imaging optical system according to a second embodiment (corresponding to a second example of numerical values):

FIG. 2B illustrates longitudinal aberration diagrams showing what state the imaging optical system assumes at respective focus positions in the second example of numerical values:

FIG. 2C illustrates lateral aberration diagrams showing a basic state and an image blur compensated state where the imaging optical system in the infinity in-focus state is making no image blur compensation, and making image blur compensation, respectively, in the second example of numerical values:

FIG. 3A illustrates a lens arrangement diagram showing an infinity in-focus state of an imaging optical system according to a third embodiment (corresponding to a third example of numerical values):

FIG. 3B illustrates longitudinal aberration diagrams showing what state the imaging optical system assumes at respective focus positions in the third example of numerical values:

FIG. 3C illustrates lateral aberration diagrams showing a basic state and an image blur compensated state where the imaging optical system in the infinity in-focus state is making no image blur compensation, and making image blur compensation, respectively, in the third example of numerical values:

FIG. 4A illustrates a lens arrangement diagram showing an infinity in-focus state of an imaging optical system according to a fourth embodiment (corresponding to a fourth example of numerical values):

FIG. 4B illustrates longitudinal aberration diagrams showing what state the imaging optical system assumes at respective focus positions in the fourth example of numerical values:

FIG. 4C illustrates lateral aberration diagrams showing a basic state and an image blur compensated state where the imaging optical system in the infinity in-focus state is making no image blur compensation, and making image blur compensation, respectively, in the fourth example of numerical values:

FIG. 5A illustrates a lens arrangement diagram showing an infinity in-focus state of an imaging optical system according to a fifth embodiment (corresponding to a fifth example of numerical values):

FIG. 5B illustrates longitudinal aberration diagrams showing what state the imaging optical system assumes at respective focus positions in the fifth example of numerical values:

FIG. 5C illustrates lateral aberration diagrams showing a basic state and an image blur compensated state where the imaging optical system in the infinity in-focus state is making no image blur compensation, and making image blur compensation, respectively, in the fifth example of numerical values:

FIG. 6 illustrates a schematic configuration for an image capture device according to the first embodiment; and

FIG. 7 illustrates a schematic configuration for a camera system according to the first embodiment.

### DETAILED DESCRIPTION

Embodiments of the present disclosure will now be described in detail with reference to the accompanying drawings as needed. Note that unnecessarily detailed description will be omitted. For example, detailed description of already well-known matters and redundant description of substantially the same configuration will be omitted. This is done to avoid making the following description overly redundant and thereby help one of ordinary skill in the art understand the present disclosure easily.

In addition, note that the applicant provides the accompanying drawings and the following description to help one of ordinary skill in the art understand the present disclosure fully and should not be construed as limiting the scope of the present disclosure, which is defined by the appended claims.

### First to Fifth Embodiments

Imaging optical systems according to first to fifth embodiments will now be described on an individual basis with reference to the accompanying drawings.

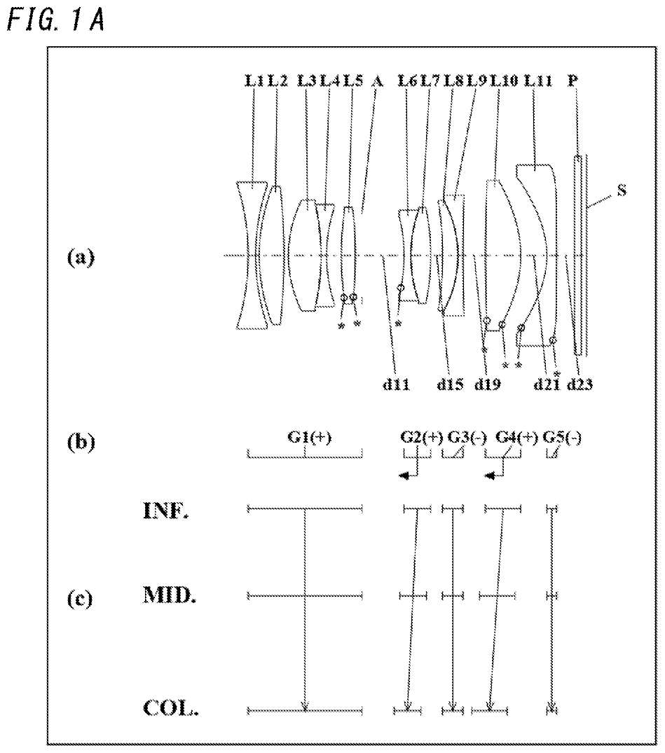

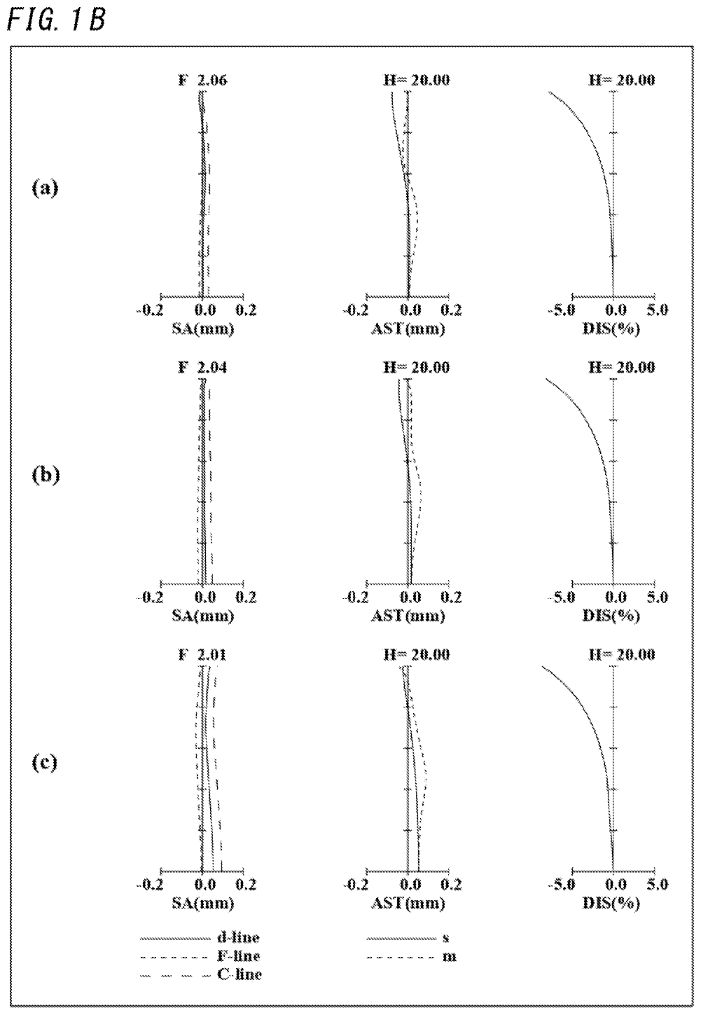

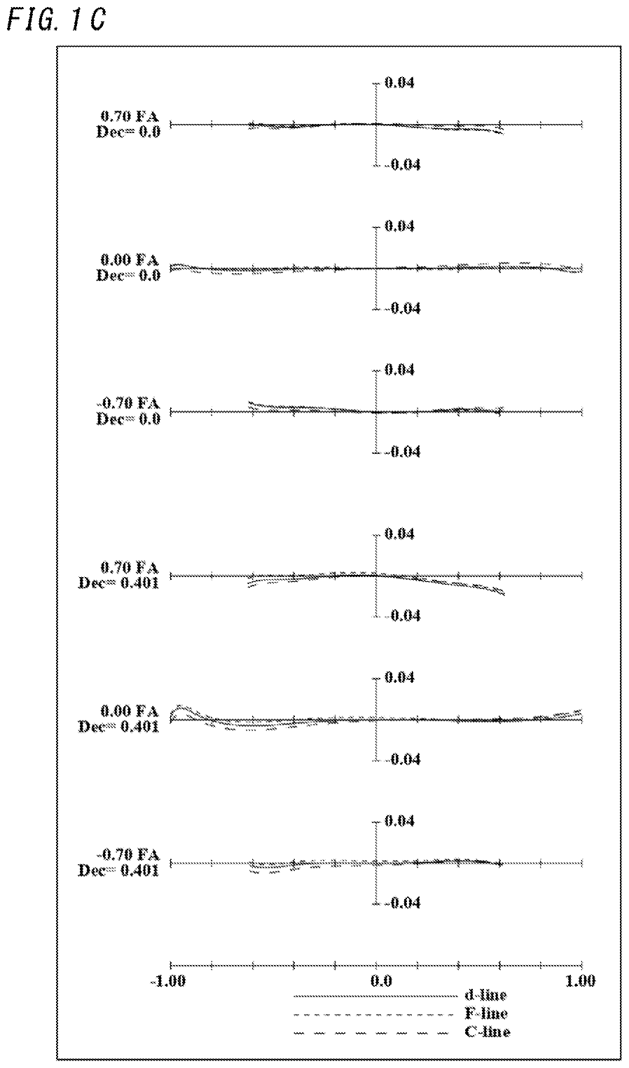

FIGS. 1A, 2A, 3A, 4A, and 5A illustrate lens arrangements of imaging optical systems according to first to fifth embodiments, respectively. In each of FIGS. 1A, 2A, 3A, 4A, and 5A, the imaging optical system is in an infinity in-focus state.

Portion (a) of FIGS. 1A, 2A, 3A, 4A, and 5A illustrates the lens arrangement in the infinity in-focus state. Note that respective portions (a) of FIGS. 1A, 2A, 3A, 4A, and 5A have the same aspect ratio.

In portion (a) of FIGS. 1A, 2A, 3A, 4A, and 5A, the asterisk (*) attached to a surface of a particular lens indicates that the surface is an aspheric surface. Note that in the lenses, an object-side surface or an image-side surface having no asterisks is a spherical surface.

Also, in FIGS. 1A, 2A, 3A, 4A, and 5A, the arrows shown in portion (c) thereof each connect together the respective positions of the lens groups in the infinity in-focus state (INF.), middle position (MID.), and close-object in-focus state (CLO.) from top to bottom. Note that these arrows just connect the infinity in-focus state to the middle position and the middle position to the close-object in-focus state with the lines, and do not indicate the actual movement of the lens groups.

In portion (b) of FIGS. 1A, 2A, 3A, 4A, and 5A, the respective lens groups are designated by the reference signs G1-G5 corresponding to their respective positions shown in portion (a).

Furthermore, the signs (+) and (−) added to the reference signs G1-G5 of the respective lens groups in portion (b) of FIGS. 1A, 2A, 3A, 4A, and 5A indicate the powers of the respective lens groups. That is to say, the positive sign (+) indicates positive power, and the negative sign (−) indicates negative power.

Also, the arrows added to the reference signs (G2 and G4) of the second and fourth lens groups in portion (b) of FIGS. 1A, 2A, 3A, 4A, and 5A and drawn parallel to the optical axis each indicate the direction of movement while the imaging optical system is focusing to make a transition from the infinity in-focus state toward the close-object in-focus state. Note that in FIGS. 1A, 2A, 3A, 4A, and 5A, the reference signs of respective lens groups are shown under the respective lens groups in portion (a) thereof, and therefore, an arrow indicating focusing is shown under the reference signs of the second and fourth lens groups for convenience's sake. The directions of movement of the second and fourth lens groups during focusing will be described more specifically later with respect to each of the first through fifth embodiments.

Furthermore, in portion (a) of FIGS. 1A, 2A, 3A, 4A, and 5A, the straight line drawn at the right end indicates the position of the image plane S (i.e., a surface, facing the object, of the image sensor). Therefore, in portion (a) of FIGS. 1A, 2A, 3A, 4A, and 5A, the left end corresponds to the object side. Furthermore, a parallel plate P such as a low-pass filter or cover glass is disposed between the lens group on the last stage, facing the image plane S, of the imaging optical system and the image plane S.

### First Embodiment

FIG. 1A illustrates an imaging optical system according to a first embodiment.

The imaging optical system consists of: a first lens group G1 having positive power: an aperture stop A: a second lens group G2 having positive power: a third lens group G3 having negative power: a fourth lens group G4 having positive power; and a fifth lens group G5 having negative power. The first lens group G1, the aperture stop A, the second lens group G2, the third lens group G3, the fourth lens group G4, and the fifth lens group G5 are arranged in this order such that the first lens group G1 is located closer to the object than the aperture stop A, the second lens group G2, the third lens group G3, the fourth lens group G4, or the fifth lens group G5 is and that the fifth lens group G5 is located closer to the image plane S than the first lens group G1, the aperture stop A, the second lens group G2, the third lens group G3, or the fourth lens group G4 is. The imaging optical system forms an image at a point on the image plane S.

The first lens group G1 is made up of: a first lens L1 having negative power: a second lens L2 having positive power: a third lens L3 having positive power: a fourth lens L4 having negative power; and a fifth lens L5 having positive power. The first lens L1, the second lens L2, the third lens L3, the fourth lens L4, and the fifth lens L5 are arranged in this order such that the first lens L1 is located closer to the object than any other member of this first lens group G1 is and that the fifth lens L5 is located closer to the image plane S than any other member of this first lens group G1 is. The third lens L3 and the fourth lens L4 are bonded together with an adhesive, for example, to form a bonded lens. That is to say, the bonded lens includes the third lens L3 and the fourth lens L4.

The second lens group G2 is made up of a sixth lens L6 having negative power and a seventh lens L7 having positive power. The sixth lens L6 and the seventh lens L7 are arranged in this order such that the sixth lens L6 is located closer to the object than the seventh lens L7 is and that the seventh lens L7 is located closer to the image plane S than the sixth lens L6 is. The sixth lens L6 and the seventh lens L7 are bonded together with an adhesive, for example, to form a bonded lens. That is to say, the bonded lens includes the sixth lens L6 and the seventh lens L7.

The third lens group G3 is made up of an eighth lens L8 having positive power and a ninth lens L9 having negative power. The eighth lens L8 and the ninth lens L9 are arranged in this order such that the eighth lens L8 is located closer to the object than the ninth lens L9 is and that the ninth lens L9 is located closer to the image plane S than the eighth lens L8 is. The eighth lens L8 and the ninth lens L9 are bonded together with an adhesive, for example, to form a bonded lens. That is to say, the bonded lens includes the eighth lens L8 and the ninth lens L9.

The fourth lens group G4 consists of a tenth lens L10 having positive power.

The fifth lens group G5 consists of an eleventh lens L11 having negative power.

The respective lenses will be described.

First, the respective lenses that form the first lens group G1 will be described. The first lens L1 is a biconcave lens. The second lens L2 is a biconvex lens. The third lens L3 is a biconvex lens. The fourth lens L4 is a biconcave lens. The fifth lens L5 is a biconvex lens. Both surfaces of the fifth lens L5 have an aspheric shape.

Next, the respective lenses that form the second lens group G2 will be described. The sixth lens L6 is a biconcave lens. The seventh lens L7 is a biconvex lens. A surface, facing the object (hereinafter referred to as an “object-side surface”) of the sixth lens L6 has an aspheric shape.

Next, the respective lenses that form the third lens group G3 will be described. The eighth lens L8 is a meniscus lens having a convex surface facing the image. The ninth lens L9 is a biconcave lens.

Next, the lens of the fourth lens group G4 will be described. The tenth lens L10 is a biconvex lens. Both surfaces of the tenth lens L10 have an aspheric shape.

Next, the lens of the fifth lens group G5 will be described. The eleventh lens L11 is a meniscus lens having a convex surface facing the image. Both surfaces of the eleventh lens L11 have an aspheric shape.

While the imaging optical system according to the first embodiment is focusing to make a transition from an infinity in-focus state toward a close-object in-focus state, the first lens group G1, the third lens group G3, and the fifth lens group G5 are located at respectively fixed distances from the image plane S in a direction aligned with an optical axis. While the imaging optical system is focusing to make a transition from the infinity in-focus state toward the close-object in-focus state during a shooting session, the second lens group G2 and the fourth lens group G4 move toward the object.

Specifically, the second lens group G2 and the fourth lens group G4 move along the optical axis such that while the imaging optical system is focusing to make a transition from the infinity in-focus state toward the close-object in-focus state, the interval between the first lens group G1 and the second lens group G2 decreases, the interval between the second lens group G2 and the third lens group G3 increases, the interval between the third lens group G3 and the fourth lens group G4 decreases, and the interval between the fourth lens group G4 and the fifth lens group G5 increases.

Note that the fifth lens L5 (serving as an image blur compensation lens), which is located closer to the image plane S than any other lens in the first lens group G1 is, moves perpendicularly to the optical axis to optically compensate for the image blur. This image blur compensation lens allows the imaging optical system to compensate for an image point shift to be caused by vibrations of the entire imaging optical system. That is to say, the imaging optical system may optically compensate for an image blur to be caused by, for example, a camera shake or vibrations.

### Second Embodiment

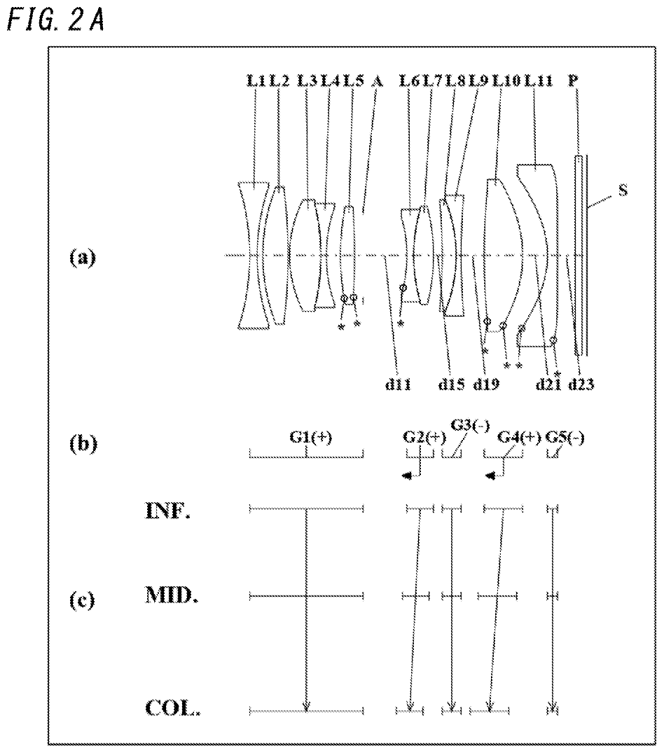

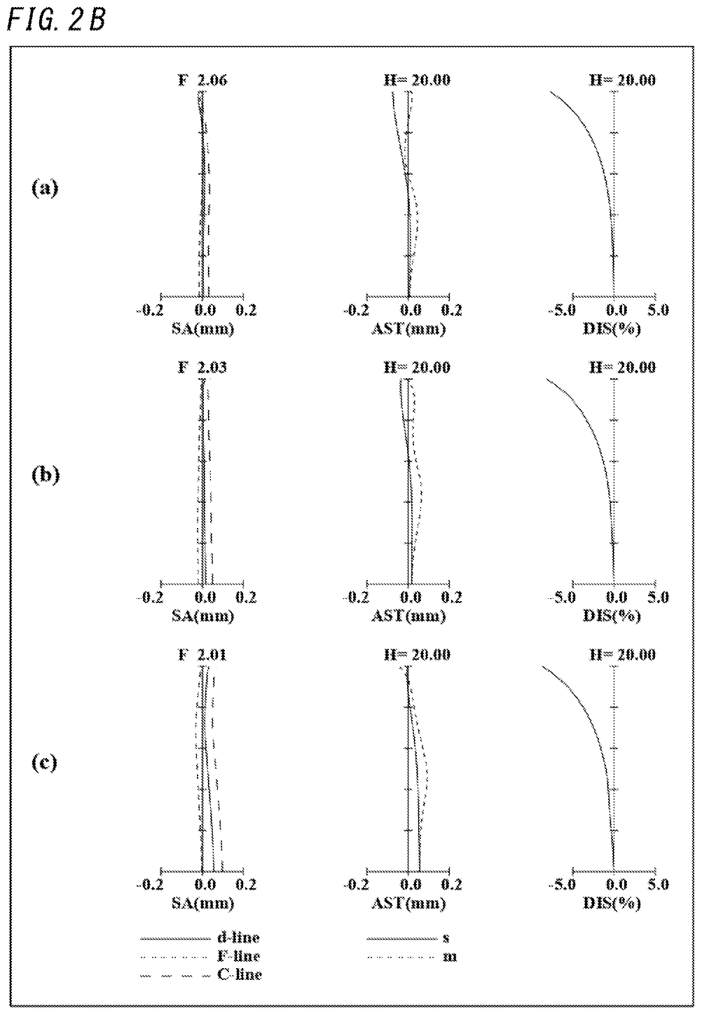

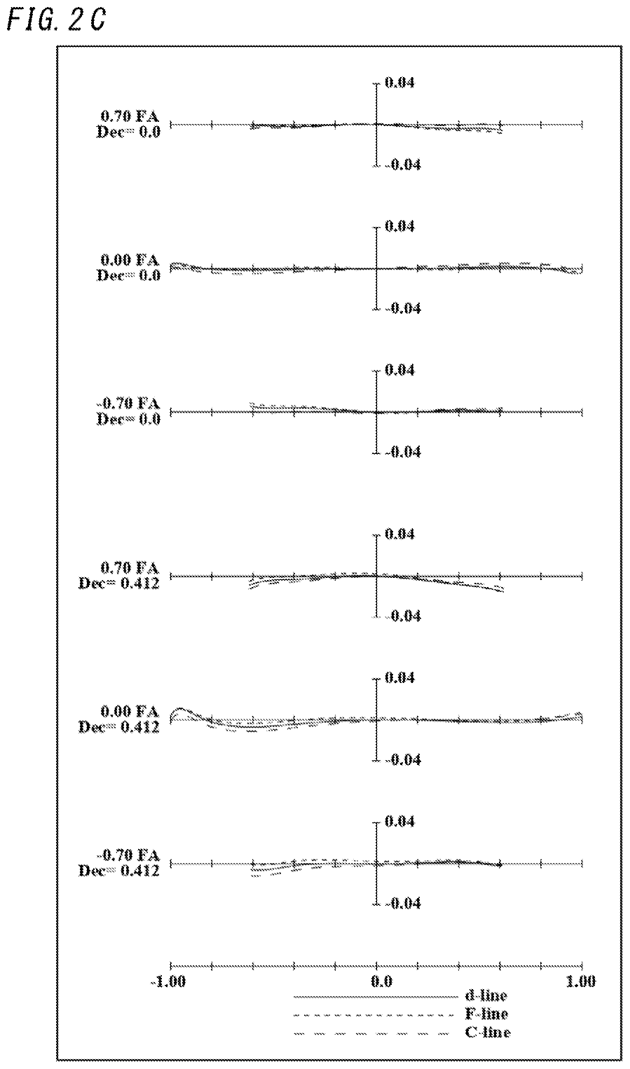

FIG. 2A illustrates an imaging optical system according to a second embodiment.

The imaging optical system consists of: a first lens group G1 having positive power: an aperture stop A: a second lens group G2 having positive power: a third lens group G3 having negative power: a fourth lens group G4 having positive power; and a fifth lens group G5 having negative power. The first lens group G1, the aperture stop A, the second lens group G2, the third lens group G3, the fourth lens group G4, and the fifth lens group G5 are arranged in this order such that the first lens group G1 is located closer to the object than the aperture stop A, the second lens group G2, the third lens group G3, the fourth lens group G4, or the fifth lens group G5 is and that the fifth lens group G5 is located closer to the image plane S than the first lens group G1, the aperture stop A, the second lens group G2, the third lens group G3, or the fourth lens group G4 is. The imaging optical system forms an image at a point on the image plane S.

The first lens group G1 is made up of: a first lens L1 having negative power: a second lens L2 having positive power: a third lens L3 having positive power: a fourth lens L4 having negative power; and a fifth lens L5 having positive power. The first lens L1, the second lens L2, the third lens L3, the fourth lens L4, and the fifth lens L5 are arranged in this order such that the first lens L1 is located closer to the object than any other member of this first lens group G1 is and that the fifth lens L5 is located closer to the image plane S than any other member of this first lens group G1 is. The third lens L3 and the fourth lens L4 are bonded together with an adhesive, for example, to form a bonded lens. That is to say, the bonded lens includes the third lens L3 and the fourth lens L4.

The second lens group G2 is made up of a sixth lens L6 having negative power and a seventh lens L7 having positive power. The sixth lens L6 and the seventh lens L7 are arranged in this order such that the sixth lens L6 is located closer to the object than the seventh lens L7 is and that the seventh lens L7 is located closer to the image plane S than the sixth lens L6 is. The sixth lens L6 and the seventh lens L7 are bonded together with an adhesive, for example, to form a bonded lens. That is to say, the bonded lens includes the sixth lens L6 and the seventh lens L7.

The third lens group G3 is made up of an eighth lens L8 having positive power and a ninth lens L9 having negative power. The eighth lens L8 and the ninth lens L9 are arranged in this order such that the eighth lens L8 is located closer to the object than the ninth lens L9 is and that the ninth lens L9 is located closer to the image plane S than the eighth lens L8 is. The eighth lens L8 and the ninth lens L9 are bonded together with an adhesive, for example, to form a bonded lens. That is to say, the bonded lens includes the eighth lens L8 and the ninth lens L9.

The fourth lens group G4 consists of a tenth lens L10 having positive power.

The fifth lens group G5 consists of an eleventh lens L11 having negative power.

The respective lenses will be described.

First, the respective lenses that form the first lens group G1 will be described. The first lens L1 is a biconcave lens. The second lens L2 is a biconvex lens. The third lens L3 is a biconvex lens. The fourth lens L4 is a biconcave lens. The fifth lens L5 is a biconvex lens.

Both surfaces of the fifth lens L5 have an aspheric shape.

Next, the respective lenses that form the second lens group G2 will be described. The sixth lens L6 is a biconcave lens. The seventh lens L7 is a biconvex lens. An object-side surface of the sixth lens L6 has an aspheric shape.

Next, the respective lenses that form the third lens group G3 will be described. The eighth lens L8 is a meniscus lens having a convex surface facing the image. The ninth lens L9 is a biconcave lens.

Next, the lens of the fourth lens group G4 will be described. The tenth lens L10 is a biconvex lens. Both surfaces of the tenth lens L10 have an aspheric shape.

Next, the lens of the fifth lens group G5 will be described. The eleventh lens L11 is a meniscus lens having a convex surface facing the image. Both surfaces of the eleventh lens L11 have an aspheric shape.

While the imaging optical system according to the second embodiment is focusing to make a transition from an infinity in-focus state toward a close-object in-focus state, the first lens group G1, the third lens group G3, and the fifth lens group G5 are located at respectively fixed distances from the image plane S in a direction aligned with an optical axis. While the imaging optical system is focusing to make a transition from the infinity in-focus state toward the close-object in-focus state during a shooting session, the second lens group G2 and the fourth lens group G4 move toward the object.

Specifically, the second lens group G2 and the fourth lens group G4 move along the optical axis such that while the imaging optical system is focusing to make a transition from the infinity in-focus state toward the close-object in-focus state, the interval between the first lens group G1 and the second lens group G2 decreases, the interval between the second lens group G2 and the third lens group G3 increases, the interval between the third lens group G3 and the fourth lens group G4 decreases, and the interval between the fourth lens group G4 and the fifth lens group G5 increases.

Note that the fifth lens L5 (serving as an image blur compensation lens), which is located closer to the image plane S than any other lens in the first lens group G1 is, moves perpendicularly to the optical axis to optically compensate for the image blur. This image blur compensation lens allows the imaging optical system to compensate for an image point shift to be caused by vibrations of the entire imaging optical system. That is to say; the imaging optical system may optically compensate for an image blur to be caused by, for example, a camera shake or vibrations.

### Third Embodiment

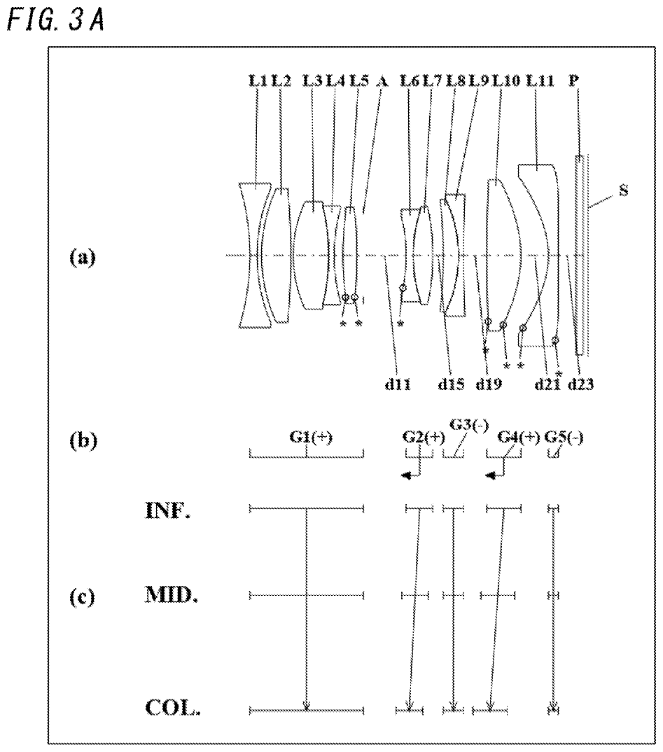

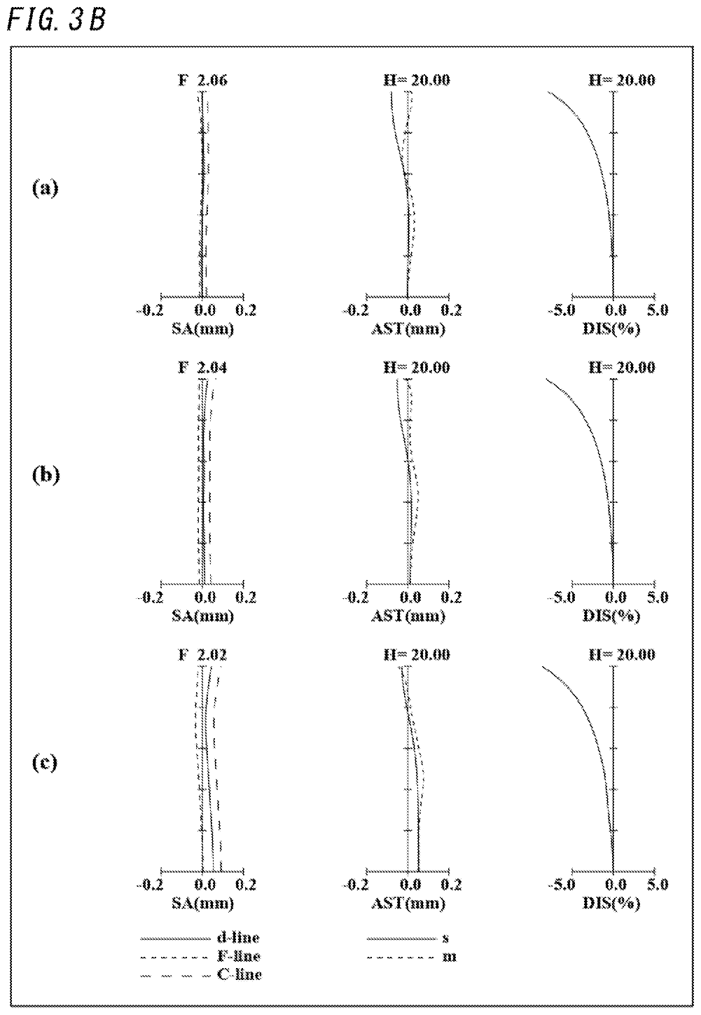

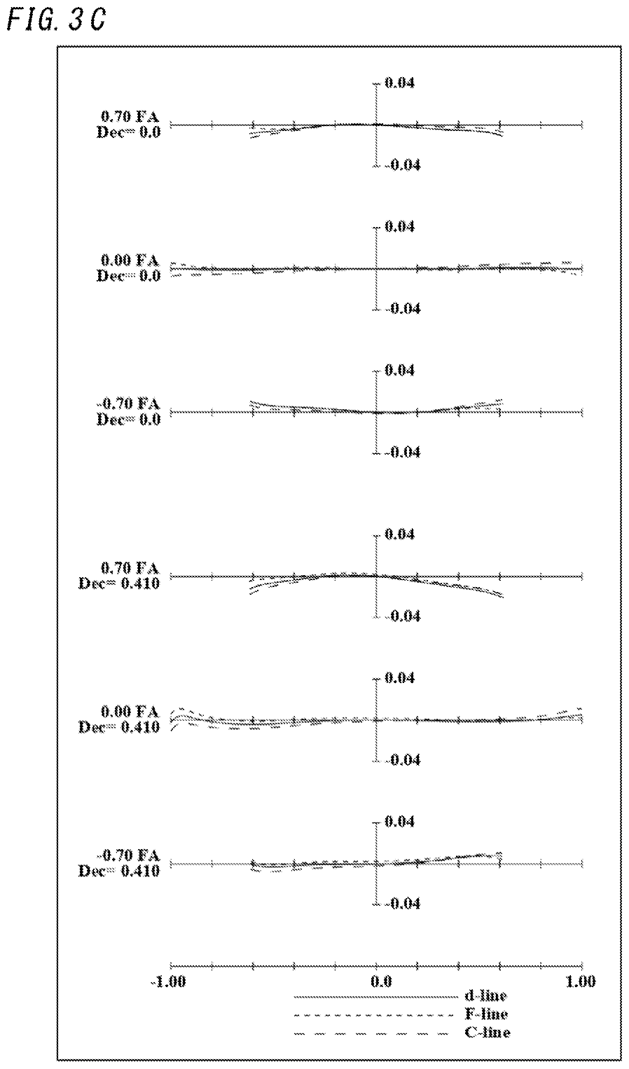

FIG. 3A illustrates an imaging optical system according to a third embodiment.

The imaging optical system consists of: a first lens group G1 having positive power: an aperture stop A: a second lens group G2 having positive power: a third lens group G3 having negative power: a fourth lens group G4 having positive power; and a fifth lens group G5 having negative power. The first lens group G1, the aperture stop A, the second lens group G2, the third lens group G3, the fourth lens group G4, and the fifth lens group G5 are arranged in this order such that the first lens group G1 is located closer to the object than the aperture stop A, the second lens group G2, the third lens group G3, the fourth lens group G4, or the fifth lens group G5 is and that the fifth lens group G5 is located closer to the image plane S than the first lens group G1, the aperture stop A, the second lens group G2, the third lens group G3, or the fourth lens group G4 is.

The imaging optical system forms an image at a point on the image plane S.

The first lens group G1 is made up of: a first lens L1 having negative power: a second lens L2 having positive power: a third lens L3 having positive power: a fourth lens L4 having negative power; and a fifth lens L5 having positive power. The first lens L1, the second lens L2, the third lens L3, the fourth lens L4, and the fifth lens L5 are arranged in this order such that the first lens L1 is located closer to the object than any other member of this first lens group G1 is and that the fifth lens L5 is located closer to the image plane S than any other member of this first lens group G1 is. The third lens L3 and the fourth lens L4 are bonded together with an adhesive, for example, to form a bonded lens. That is to say, the bonded lens includes the third lens L3 and the fourth lens L4.

The second lens group G2 is made up of a sixth lens L6 having negative power and a seventh lens L7 having positive power. The sixth lens L6 and the seventh lens L7 are arranged in this order such that the sixth lens L6 is located closer to the object than the seventh lens L7 is and that the seventh lens L7 is located closer to the image plane S than the sixth lens L6 is. The sixth lens L6 and the seventh lens L7 are bonded together with an adhesive, for example, to form a bonded lens. That is to say, the bonded lens includes the sixth lens L6 and the seventh lens L7.

The third lens group G3 is made up of an eighth lens L8 having positive power and a ninth lens L9 having negative power. The eighth lens L8 and the ninth lens L9 are arranged in this order such that the eighth lens L8 is located closer to the object than the ninth lens L9 is and that the ninth lens L9 is located closer to the image plane S than the eighth lens L8 is. The eighth lens L8 and the ninth lens L9 are bonded together with an adhesive, for example, to form a bonded lens. That is to say, the bonded lens includes the eighth lens L8 and the ninth lens L9.

The fourth lens group G4 consists of a tenth lens L10 having positive power.

The fifth lens group G5 consists of an eleventh lens L11 having negative power.

The respective lenses will be described.

First, the respective lenses that form the first lens group G1 will be described. The first lens L1 is a biconcave lens. The second lens L2 is a biconvex lens. The third lens L3 is a biconvex lens. The fourth lens L4 is a biconcave lens. The fifth lens L5 is a biconvex lens. Both surfaces of the fifth lens L5 have an aspheric shape.

Next, the respective lenses that form the second lens group G2 will be described. The sixth lens L6 is a biconcave lens. The seventh lens L7 is a biconvex lens. An object-side surface of the sixth lens L6 has an aspheric shape.

Next, the respective lenses that form the third lens group G3 will be described. The eighth lens L8 is a meniscus lens having a convex surface facing the image. The ninth lens L9 is a biconcave lens.

Next, the lens of the fourth lens group G4 will be described. The tenth lens L10 is a biconvex lens. Both surfaces of the tenth lens L10 have an aspheric shape.

Next, the lens of the fifth lens group G5 will be described. The eleventh lens L11 is a meniscus lens having a convex surface facing the image. Both surfaces of the eleventh lens L11 have an aspheric shape.

While the imaging optical system according to the third embodiment is focusing to make a transition from an infinity in-focus state toward a close-object in-focus state, the first lens group G1, the third lens group G3, and the fifth lens group G5 are located at respectively fixed distances from the image plane S in a direction aligned with an optical axis. While the imaging optical system is focusing to make a transition from the infinity in-focus state toward the close-object in-focus state during a shooting session, the second lens group G2 and the fourth lens group G4 move toward the object.

Specifically, the second lens group G2 and the fourth lens group G4 move along the optical axis such that while the imaging optical system is focusing to make a transition from the infinity in-focus state toward the close-object in-focus state, the interval between the first lens group G1 and the second lens group G2 decreases, the interval between the second lens group G2 and the third lens group G3 increases, the interval between the third lens group G3 and the fourth lens group G4 decreases, and the interval between the fourth lens group G4 and the fifth lens group G5 increases.

Note that the fifth lens L5 (serving as an image blur compensation lens), which is located closer to the image plane S than any other lens in the first lens group G1 is, moves perpendicularly to the optical axis to optically compensate for the image blur. This image blur compensation lens allows the imaging optical system to compensate for an image point shift to be caused by vibrations of the entire imaging optical system. That is to say, the imaging optical system may optically compensate for an image blur to be caused by, for example, a camera shake or vibrations.

### Fourth Embodiment

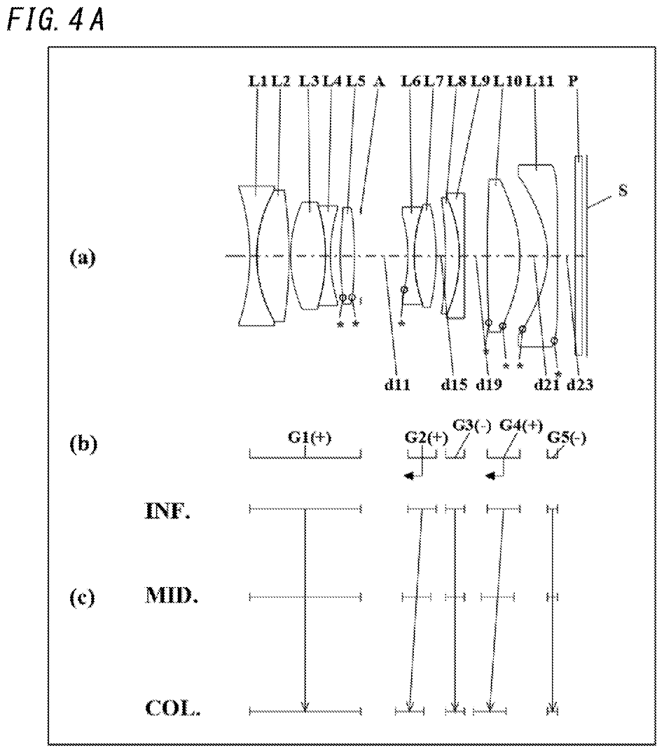

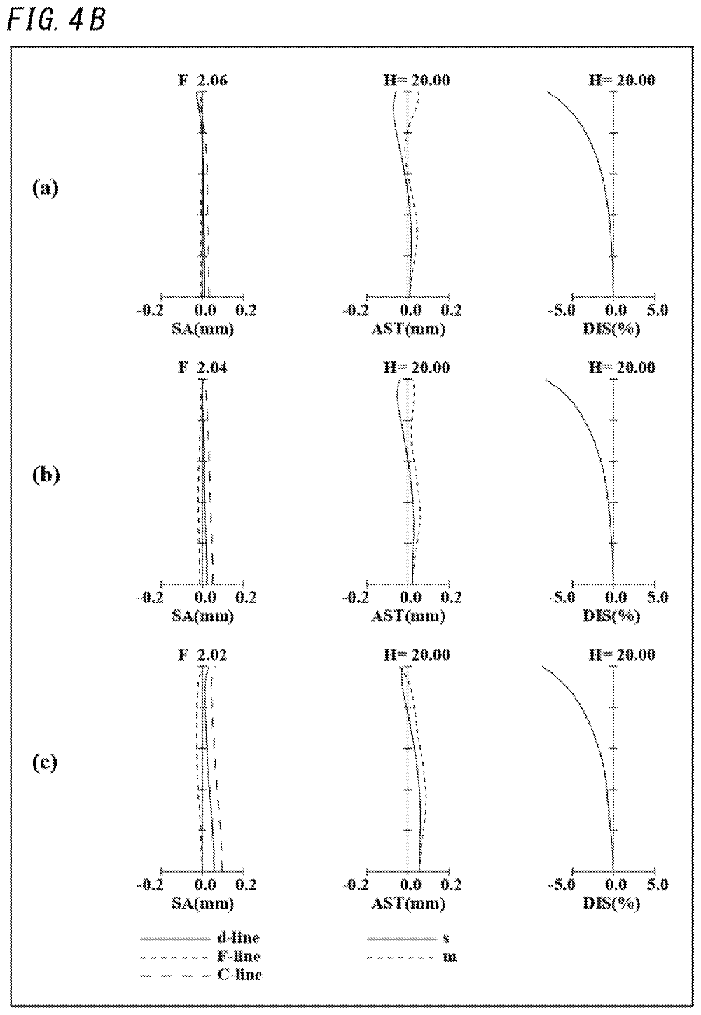

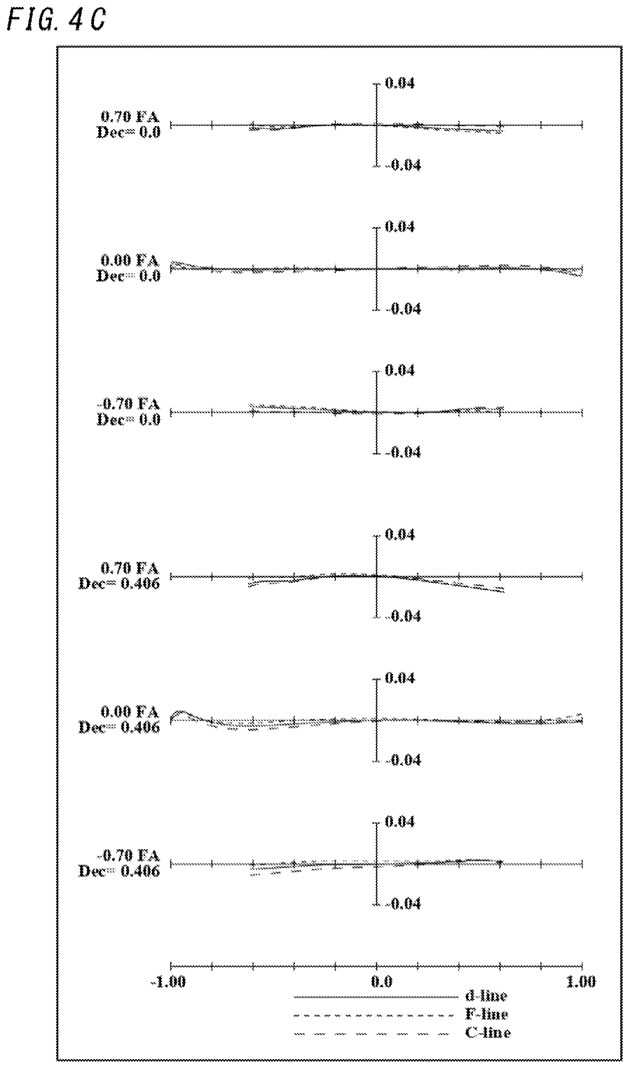

FIG. 4A illustrates an imaging optical system according to a fourth embodiment.

The imaging optical system consists of: a first lens group G1 having positive power: an aperture stop A: a second lens group G2 having positive power: a third lens group G3 having negative power: a fourth lens group G4 having positive power; and a fifth lens group G5 having negative power. The first lens group G1, the aperture stop A, the second lens group G2, the third lens group G3, the fourth lens group G4, and the fifth lens group G5 are arranged in this order such that the first lens group G1 is located closer to the object than the aperture stop A, the second lens group G2, the third lens group G3, the fourth lens group G4, or the fifth lens group G5 is and that the fifth lens group G5 is located closer to the image plane S than the first lens group G1, the aperture stop A, the second lens group G2, the third lens group G3, or the fourth lens group G4 is.

The imaging optical system forms an image at a point on the image plane S.

The first lens group G1 is made up of: a first lens L1 having negative power: a second lens L2 having positive power: a third lens L3 having positive power: a fourth lens L4 having negative power; and a fifth lens L5 having positive power. The first lens L1, the second lens L2, the third lens L3, the fourth lens L4, and the fifth lens L5 are arranged in this order such that the first lens L1 is located closer to the object than any other member of this first lens group G1 is and that the fifth lens L5 is located closer to the image plane S than any other member of this first lens group G1 is. The first lens L1 and the second lens L2 are bonded together with an adhesive, for example, to form a bonded lens. That is to say, the bonded lens includes the first lens L1 and the second lens L2. The third lens L3 and the fourth lens L4 are bonded together with an adhesive, for example, to form a bonded lens. That is to say, the bonded lens includes the third lens L3 and the fourth lens L4.

The second lens group G2 is made up of a sixth lens L6 having negative power and a seventh lens L7 having positive power. The sixth lens L6 and the seventh lens L7 are arranged in this order such that the sixth lens L6 is located closer to the object than the seventh lens L7 is and that the seventh lens L7 is located closer to the image plane S than the sixth lens L6 is. The sixth lens L6 and the seventh lens L7 are bonded together with an adhesive, for example, to form a bonded lens. That is to say, the bonded lens includes the sixth lens L6 and the seventh lens L7.

The third lens group G3 is made up of an eighth lens L8 having positive power and a ninth lens L9 having negative power. The eighth lens L8 and the ninth lens L9 are arranged in this order such that the eighth lens L8 is located closer to the object than the ninth lens L9 is and that the ninth lens L9 is located closer to the image plane S than the eighth lens L8 is. The eighth lens L8 and the ninth lens L9 are bonded together with an adhesive, for example, to form a bonded lens. That is to say, the bonded lens includes the eighth lens L8 and the ninth lens L9.

The fourth lens group G4 consists of a tenth lens L10 having positive power.

The fifth lens group G5 consists of an eleventh lens L11 having negative power.

The respective lenses will be described.

First, the respective lenses that form the first lens group G1 will be described. The first lens L1 is a biconcave lens. The second lens L2 is a biconvex lens. The third lens L3 is a biconvex lens. The fourth lens L4 is a biconcave lens. The fifth lens L5 is a biconvex lens. Both surfaces of the fifth lens L5 have an aspheric shape.

Next, the respective lenses that form the second lens group G2 will be described. The sixth lens L6 is a biconcave lens. The seventh lens L7 is a biconvex lens. An object-side surface of the sixth lens L6 has an aspheric shape.

Next, the respective lenses that form the third lens group G3 will be described. The eighth lens L8 is a meniscus lens having a convex surface facing the image. The ninth lens L9 is a plano-concave lens having a concave surface facing the object.

Next, the lens of the fourth lens group G4 will be described. The tenth lens L10 is a biconvex lens. Both surfaces of the tenth lens L10 have an aspheric shape.

Next, the lens of the fifth lens group G5 will be described. The eleventh lens L11 is a meniscus lens having a convex surface facing the image. Both surfaces of the eleventh lens L11 have an aspheric shape.

While the imaging optical system according to the fourth embodiment is focusing to make a transition from an infinity in-focus state toward a close-object in-focus state, the first lens group G1, the third lens group G3, and the fifth lens group G5 are located at respectively fixed distances from the image plane S in a direction aligned with an optical axis. While the imaging optical system is focusing to make a transition from the infinity in-focus state toward the close-object in-focus state during a shooting session, the second lens group G2 and the fourth lens group G4 move toward the object.

Specifically, the second lens group G2 and the fourth lens group G4 move along the optical axis such that while the imaging optical system is focusing to make a transition from the infinity in-focus state toward the close-object in-focus state, the interval between the first lens group G1 and the second lens group G2 decreases, the interval between the second lens group G2 and the third lens group G3 increases, the interval between the third lens group G3 and the fourth lens group G4 decreases, and the interval between the fourth lens group G4 and the fifth lens group G5 increases.

Note that the fifth lens L5 (serving as an image blur compensation lens), which is located closer to the image plane S than any other lens in the first lens group G1 is, moves perpendicularly to the optical axis to optically compensate for the image blur. This image blur compensation lens allows the imaging optical system to compensate for an image point shift to be caused by vibrations of the entire imaging optical system. That is to say, the imaging optical system may optically compensate for an image blur to be caused by, for example, a camera shake or vibrations.

### Fifth Embodiment

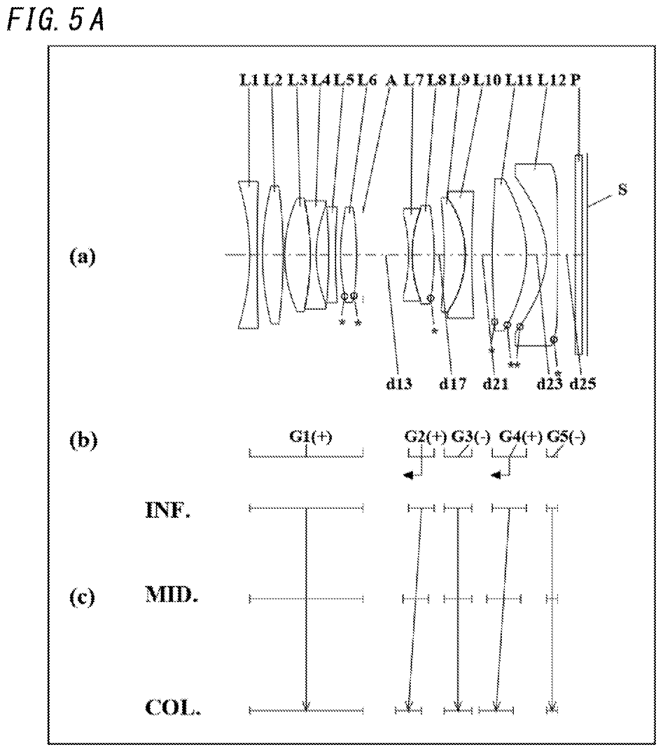

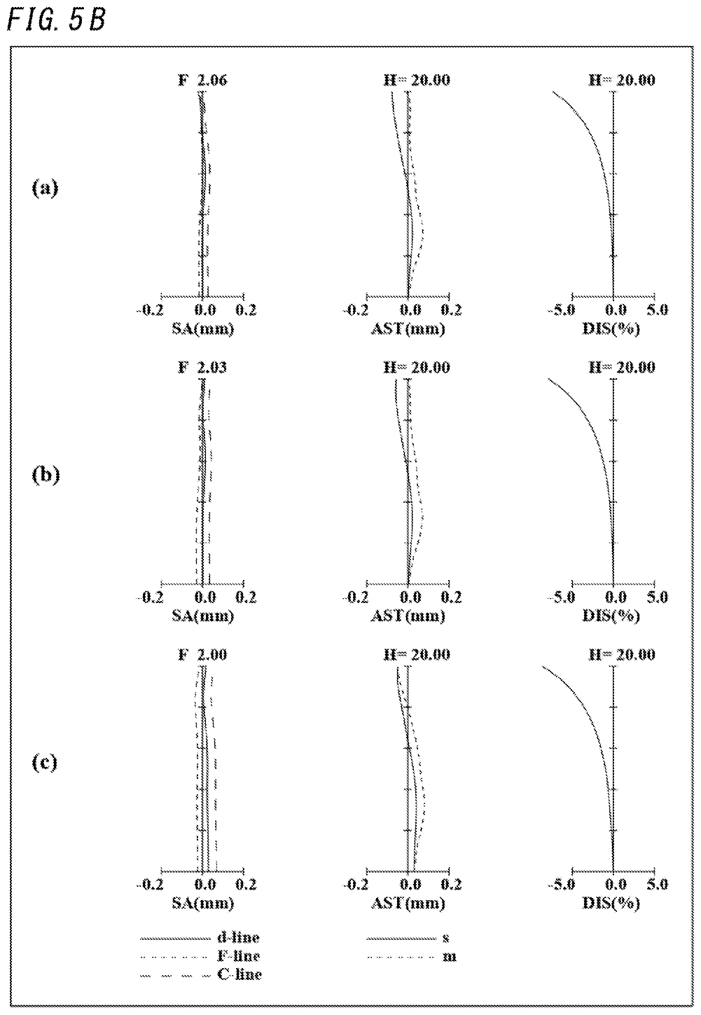

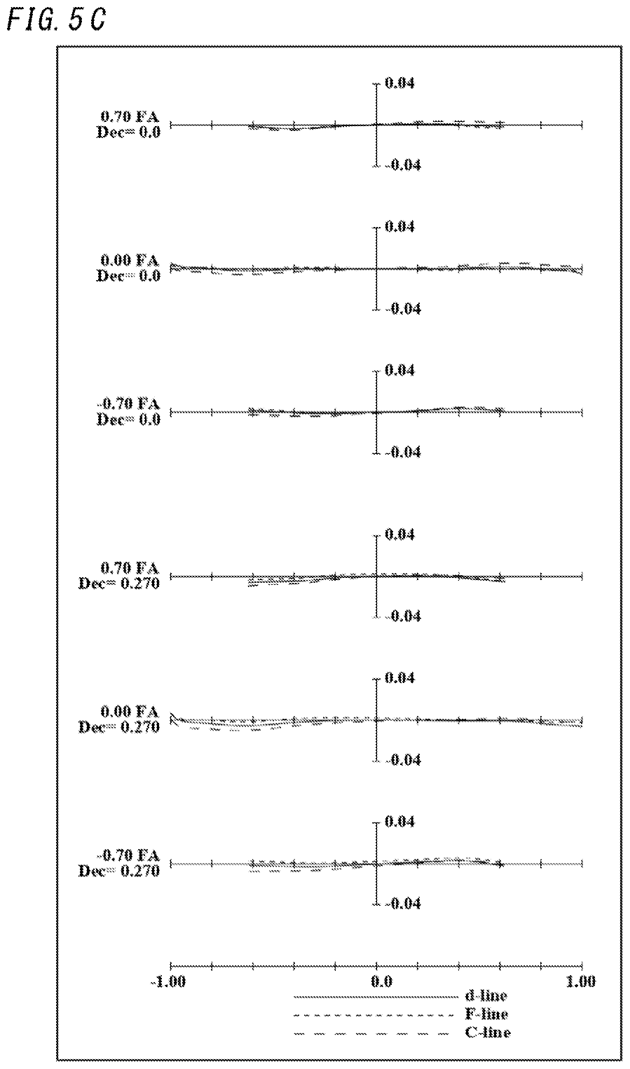

FIG. 5A illustrates an imaging optical system according to a fifth embodiment.

The imaging optical system consists of: a first lens group G1 having positive power: an aperture stop A: a second lens group G2 having positive power: a third lens group G3 having negative power: a fourth lens group G4 having positive power; and a fifth lens group G5 having negative power. The first lens group G1, the aperture stop A, the second lens group G2, the third lens group G3, the fourth lens group G4, and the fifth lens group G5 are arranged in this order such that the first lens group G1 is located closer to the object than the aperture stop A, the second lens group G2, the third lens group G3, the fourth lens group G4, or the fifth lens group G5 is and that the fifth lens group G5 is located closer to the image plane S than the first lens group G1, the aperture stop A, the second lens group G2, the third lens group G3, or the fourth lens group G4 is.

The imaging optical system forms an image at a point on the image plane S.

The first lens group G1 is made up of: a first lens L1 having negative power: a second lens L2 having positive power: a third lens L3 having positive power: a fourth lens L4 having negative power: a fifth lens L5 having negative power; and a sixth lens L6 having positive power. The first lens L1, the second lens L2, the third lens L3, the fourth lens L4, the fifth lens L5, and the sixth lens L6 are arranged in this order such that the first lens L1 is located closer to the object than any other member of this first lens group G1 is and that the sixth lens L6 is located closer to the image plane S than any other member of this first lens group G1 is. The third lens L3 and the fourth lens L4 are bonded together with an adhesive, for example, to form a bonded lens. That is to say; the bonded lens includes the third lens L3 and the fourth lens L4.

The second lens group G2 is made up of a seventh lens L7 having negative power and an eighth lens L8 having positive power. The seventh lens L7 and the eighth lens L8 are arranged in this order such that the seventh lens L7 is located closer to the object than the eighth lens L8 is and that the eighth lens L8 is located closer to the image plane S than the seventh lens L7 is. The seventh lens L7 and the eighth lens L8 are bonded together with an adhesive, for example, to form a bonded lens. That is to say, the bonded lens includes the seventh lens L7 and the eighth lens L8.

The third lens group G3 is made up of a ninth lens L9 having positive power and a tenth lens L10 having negative power. The ninth lens L9 and the tenth lens L10 are arranged in this order such that the ninth lens L9 is located closer to the object than the tenth lens L10 is and that the tenth lens L10 is located closer to the image plane S than the ninth lens L9 is. The ninth lens L9 and the tenth lens L10 are bonded together with an adhesive, for example, to form a bonded lens. That is to say, the bonded lens includes the ninth lens L9 and the tenth lens L10.

The fourth lens group G4 consists of an eleventh lens L11 having positive power.

The fifth lens group G5 consists of a twelfth lens L12 having negative power.

The respective lenses will be described.

First, the respective lenses that form the first lens group G1 will be described. The first lens L1 is a biconcave lens. The second lens L2 is a biconvex lens. The third lens L3 is a biconvex lens. The fourth lens L4 is a biconcave lens. The fifth lens L5 is a biconcave lens. The sixth lens L6 is a biconvex lens. Both surfaces of the sixth lens L6 have an aspheric shape.

Next, the respective lenses that form the second lens group G2 will be described. The seventh lens L7 is a biconcave lens. The eighth lens L8 is a biconvex lens. An image-side surface of the eighth lens L8 has an aspheric shape.

Next, the respective lenses that form the third lens group G3 will be described. The ninth lens L9 is a meniscus lens having a convex surface facing the image. The tenth lens L10 is a biconcave lens.

Next, the lens of the fourth lens group G4 will be described. The eleventh lens L11 is a biconvex lens. Both surfaces of the eleventh lens L11 have an aspheric shape.

Next, the lens of the fifth lens group G5 will be described. The twelfth lens L12 is a meniscus lens having a convex surface facing the image. Both surfaces of the twelfth lens L12 have an aspheric shape.

While the imaging optical system according to the fifth embodiment is focusing to make a transition from an infinity in-focus state toward a close-object in-focus state, the first lens group G1, the third lens group G3, and the fifth lens group G5 are located at respectively fixed distances from the image plane S in a direction aligned with an optical axis. While the imaging optical system is focusing to make a transition from the infinity in-focus state toward the close-object in-focus state during a shooting session, the second lens group G2 and the fourth lens group G4 move toward the object.

Specifically, the second lens group G2 and the fourth lens group G4 move along the optical axis such that while the imaging optical system is focusing to make a transition from the infinity in-focus state toward the close-object in-focus state, the interval between the first lens group G1 and the second lens group G2 decreases, the interval between the second lens group G2 and the third lens group G3 increases, the interval between the third lens group G3 and the fourth lens group G4 decreases, and the interval between the fourth lens group G4 and the fifth lens group G5 increases.

Note that the sixth lens L6 (serving as an image blur compensation lens), which is located closer to the image plane S than any other lens in the first lens group G1 is, moves perpendicularly to the optical axis to optically compensate for the image blur. This image blur compensation lens allows the imaging optical system to compensate for an image point shift to be caused by vibrations of the entire imaging optical system. That is to say, the imaging optical system may optically compensate for an image blur to be caused by, for example, a camera shake or vibrations.

### Other Embodiments

The first, second, third, fourth, and fifth embodiments have been described as exemplary embodiments of the present disclosure. Note that the embodiments described above are only examples of the present disclosure and should not be construed as limiting. Rather, each of these embodiments may be readily modified, replaced, combined with other embodiments, provided with some additional components, or partially omitted without departing from the scope of the present disclosure.

The number of the lens groups and the number of the lenses that form each lens group are substantial numbers. Optionally, a lens having substantially no power may be added to any of the lens groups described above.

Also, the imaging optical systems according to the first, second, third, fourth, and fifth embodiments described above are configured to compensate for an image blur by shifting the image blur compensation lens perpendicularly to the optical axis. However, this is only an example and should not be construed as limiting. Alternatively, the image blur may also be compensated for as long as the lens is shifted to have a component perpendicular to the optical axis. Thus, if the lens barrel may have a complex structure, for example, the imaging optical system may also be configured to compensate for the image blur by pivoting the image blur compensation lens around a center on the optical axis.

### Conditions and Advantages

Next, conditions for implementing the imaging optical systems according to the first to fifth embodiments, for example, will be described. A plurality of possible conditions may be defined for the imaging optical system according to each of these five embodiments. In that case, an imaging optical system, of which the configuration satisfies all of these possible conditions, is most advantageous. Alternatively, an imaging optical system that achieves its expected advantages by satisfying any of the individual conditions to be described below may also be provided.

An imaging optical system according to each of the first to fifth embodiments described above consists of: a first lens group G1 having positive power: an aperture stop A: a second lens group G2 having positive power: a third lens group G3 having negative power: a fourth lens group G4 having positive power; and a fifth lens group G5 having negative power. The first lens group G1, the aperture stop A, the second lens group G2, the third lens group G3, the fourth lens group G4, and the fifth lens group G5 are arranged in this order such that the first lens group G1 is located closer to an object than the aperture stop A, the second lens group G2, the third lens group G3, the fourth lens group G4, or the fifth lens group G5 is. While the imaging optical system is focusing to make a transition from an infinity in-focus state toward a close-object in-focus state, the first lens group G1, the third lens group G3, and the fifth lens group G5 are located at respectively fixed distances from an image plane S in a direction aligned with an optical axis, and the second lens group G2 and the fourth lens group G4 move along the optical axis. As a result, intervals between respective lens groups change.

This enables providing an imaging optical system in which various types of aberrations have been compensated for sufficiently over the entire focus range although the imaging optical system has a small size.

An imaging optical system having the basic configuration described above preferably satisfies, for example, the condition expressed by the following Inequality (1):

$$1. < f 1 / f < 1.5 \qquad ( 1 )$$

Where f1 is a focal length of the first lens group G1 and f is a focal length of the imaging optical system in the infinity in-focus state.

The condition expressed by this Inequality (1) defines a preferred ratio of the focal length of the first lens group G1 to the focal length of the entire imaging optical system in the infinity in-focus state. Satisfying the condition expressed by this Inequality (1) enables providing an imaging optical system with the ability to compensate for various types of aberrations sufficiently.

If f1/f were equal to or less than the lower limit value set by this Inequality (1), then various types of aberrations (e.g., field curvature, among other things) would be caused so significantly as to make it difficult to ensure good performance. If f1/f were equal to or greater than the upper limit value set by this Inequality (1), then various types of aberrations (e.g., coma aberration, among other things) would be caused so significantly as to make it difficult to ensure good performance.

To enhance the advantage described above, at least one of the conditions expressed by the following Inequalities (1a) and (1b) is preferably satisfied:

$$1.1 < f 1 / f \qquad ( 1 a )$$

$$f 1 / f < 1.4 . \qquad ( 1 b )$$

To further enhance the advantage described above, at least one of the conditions expressed by the following Inequalities (1c) and (1d) is more preferably satisfied:

$$1.2 < f 1 / f \qquad ( 1 c )$$

$$f 1 / f < 1.35 . \qquad ( 1 d )$$

The imaging optical system preferably satisfies, for example, the condition expressed by the following Inequality (2):

$$0.5 < \vert f 5 / f \vert < 1. \qquad ( 2 )$$

Where f5 is a focal length of the fifth lens group G5, and f is a focal length of the imaging optical system in the infinity in-focus state.

The condition expressed by this Inequality (2) defines a preferred ratio of the focal length of the fifth lens group G5 to the focal length of the entire imaging optical system in the infinity in-focus state. If |f5/f| were equal to or less than the lower limit value set by this Inequality (2), then various types of aberrations (e.g., coma aberration and astigmatism, among other things) would be caused so significantly as to make it difficult to ensure good performance. If |f5/f| were equal to or greater than the upper limit value set by this Inequality (2), then various types of aberrations (e.g., astigmatism, among other things) would be caused so significantly as to make it difficult to ensure good performance.

To enhance the advantage described above, at least one of the conditions expressed by the following Inequalities (2a) and (2b) is preferably satisfied:

$$0.55 < \vert f 5 / f \vert \qquad ( 2 a )$$

$$\vert f 5 / f \vert < 0.9 . \qquad ( 2 b )$$

To further enhance the advantage described above, at least one of the conditions expressed by the following Inequalities (2c) and (2d) is more preferably satisfied:

$$0.6 < \vert f 5 / f \vert \qquad ( 2 c )$$

$$\vert f 5 / f \vert < 0.8 . \qquad ( 2 d )$$

The imaging optical system preferably satisfies, for example, the condition expressed by the following Inequality (3):

$$1.8 \leq f 2 / f 4 \leq 3.4 \qquad ( 3 )$$

Where f2 is a focal length of the second lens group G2 and f4 is a focal length of the fourth lens group G4.

The condition expressed by this Inequality (3) defines a preferred ratio of the focal length of the second lens group G2 to the focal length of the fourth lens group G4. Satisfying the condition expressed by this Inequality (3) enables compensating for various types of aberrations effectively while reducing the overall size of the imaging optical system.

If f2/f4 were less than the lower limit value set by this Inequality (3), then various types of aberrations (e.g., spherical aberration and field curvature, among other things) would be caused so significantly as to make it difficult to ensure good performance. If f2/f4 were greater than the upper limit value set by this Inequality (3), then various types of aberrations (e.g., spherical aberration and astigmatism, among other things) would be caused so significantly as to make it difficult to ensure good performance.

To enhance the advantage described above, at least one of the conditions expressed by the following Inequalities (3a) and (3b) is preferably satisfied:

$$2.0 \leq f 2 / f 4 \qquad ( 3 a )$$

$$f 2 / f 4 \leq 3.2 . \qquad ( 3 b )$$

To further enhance the advantage described above, at least one of the conditions expressed by the following Inequalities (3c) and (3d) is more preferably satisfied:

$$2.2 \leq f 2 / f 4 \qquad ( 3 c )$$

$$f 2 / f 4 \leq 3. . \qquad ( 3 d )$$

The fifth lens group of the imaging optical system may include a lens having negative power and located closest to the image plane S. In that case, the imaging optical system preferably satisfies, for example, the following Inequality (4):

$$0.1 < BF / Y < 0.5 \qquad ( 4 )$$

Where BF is a distance on the optical axis from a lens surface, facing the image plane, of the lens of the fifth lens group G5 to the image plane S, and Y is a maximum image height of the imaging optical system in the infinity in-focus state.

The lens having negative power and located closest to the image plane S in the fifth lens group G5 refers to the eleventh lens L11 in the first to fourth embodiments and refers to the twelfth lens L12 in the fifth embodiment.

The condition expressed by this Inequality (4) defines a preferred ratio of the back focus of the imaging optical system to the maximum image height of the imaging optical system in the infinity in-focus state. If BF/Y were equal to or less than the lower limit value set by this Inequality (4), then the back focus value would be so small as to cause interference often between the lens located closest to the image plane S in the fifth lens group G5 and the image sensor, which is unfavorable. If BF/Y were equal to or greater than the upper limit value set by this Inequality (4), then the back focus value would be so large as to cause a significant increase in the overall size of the lens, which is also unbeneficial.

To enhance the advantage described above, at least one of the conditions expressed by the following Inequalities (4a) and (4b) is preferably satisfied:

$$0.22 < BF / Y \qquad ( 4 a )$$

$$BF / Y < 0 \text{.38} . \qquad ( 4 b )$$

To further enhance the advantage described above, at least one of the conditions expressed by the following Inequalities (4c) and (4d) is more preferably satisfied:

$$0.24 < BF / Y \qquad ( 4 c )$$

$$BF / Y < 0 \text{.36} . \qquad ( 4 d )$$

The imaging optical system preferably satisfies, for example, the condition expressed by the following Inequality (5):

$$3. 0 < TL / Y < 3.8 \qquad ( 5 )$$

Where TL is a total optical length of the imaging optical system in the infinity in-focus state, and Y is a maximum image height of the imaging optical system in the infinity in-focus state.

The condition expressed by this Inequality (5) defines a preferred ratio of the total optical length of the imaging optical system in the infinity in-focus state (i.e., a distance on the optical axis from a lens surface located closest to the object to the image plane) to the maximum image height of the imaging optical system in the infinity in-focus state.

If TL/Y were equal to or less than the lower limit set by this Inequality (5), then it would be difficult to compensate for the aberrations of an axial bundle of rays and a radial bundle of rays, which is not beneficial. If TL/Y were equal to or greater than the upper limit set by this Inequality (5), then it would be difficult to reduce the overall size of the imaging optical system.

To enhance the advantage described above, at least one of the conditions expressed by the following Inequalities (5a) and (5b) is preferably satisfied:

$$3.1 < TL / Y \qquad ( 5 a )$$

$$TL / Y < 3.7 . \qquad ( 5 b )$$

To further enhance the advantage described above, at least one of the conditions expressed by the following Inequalities (5c) and (5d) is more preferably satisfied:

$$3.3 < TL / Y \qquad ( 5 c )$$

$$TL / Y < 3.5 . \qquad ( 5 d )$$

In the imaging optical system, the second lens group G2 may include a plurality of lenses. The plurality of lenses may include: a lens having negative power and located closest to the object in the plurality of lenses; and a lens having positive power and located second closest to the object in the plurality of lenses. In that case, the imaging optical system preferably satisfies, for example, the following Inequality (6):

$$1.8 < n d 2 G p \qquad ( 6 )$$

Where nd2Gp is a refractive index of the lens having positive power and included in the second lens group G2.

The condition expressed by this Inequality (6) defines a preferred refractive index of the lens having positive power and belonging to the second lens group G2. If nd2Gp were equal to or less than the lower limit set by this Inequality (6), then it would be difficult to compensate for various types of aberrations (e.g., astigmatism and field curvature, among other things) with adequate balance struck.

To enhance the advantage described above, the condition expressed by the following Inequality (6a) is preferably satisfied:

$$1. 82 < n d 2 Gp . \qquad ( 6 a )$$

The following Inequality (6b) sets a preferred upper limit for the refractive index nd2Gp, of which the lower limit value is set by Inequality (6):

$$n d 2 G p < 2.1 . \qquad ( 6 b )$$

If nd2Gp were equal to or greater than the upper limit set by this Inequality (6b), then it would be difficult to compensate for the field curvature sufficiently. In that case, the condition expressed by this Inequality (6b) is preferably satisfied with either the condition expressed by Inequality (6) or the condition expressed by Inequality (6a) satisfied.

To further enhance the advantage described above, at least one of the conditions expressed by the following Inequalities (6c) and (6d) is more preferably satisfied:

$$1.84 < n d2Gp \qquad ( 6 c )$$

$$nd 2 Gp < 2. . \qquad ( 6 d )$$

The fourth lens group G4 may consist of a single lens. In that case, the imaging optical system preferably satisfies, for example, the condition expressed by the following Inequality (7):

$$62 < v d 4 G \qquad ( 7 )$$

Where vd4G is an Abbe number of the lens of the fourth lens group G4.

The condition expressed by this Inequality (7) defines a preferred range for the Abbe number of the lens of the fourth lens group G4. If vd4G were equal to or less than the lower limit set by this Inequality (7), then it would be difficult to compensate for various types of aberrations (e.g., chromatic aberration, among other things) with adequate balance struck.

To enhance the advantage described above, the condition expressed by the following Inequality (7a) is preferably satisfied:

$$65 < v d 4 G . \qquad ( 7 a )$$

The following Inequality (7b) sets a preferred upper limit for the Abbe number vd4G, of which the lower limit value is set by Inequality (7):

$$v d 4 G < 100 . \qquad ( 7 b )$$

If vd4G were equal to or greater than the upper limit set by this Inequality (7b), then it would be difficult to compensate for chromatic aberration sufficiently. In that case, the condition expressed by this Inequality (7b) is preferably satisfied with either the condition expressed by Inequality (7) or the condition expressed by Inequality (7a) satisfied.

To further enhance the advantage described above, at least one of the conditions expressed by the following Inequalities (7c) and (7d) is more preferably satisfied:

$$70 < vd 4 G \qquad ( 7 c )$$

$$vd 4 G < 85. \qquad ( 7 d )$$

In the imaging optical system, the fifth lens group G5 may consist of a single lens. In that case, the imaging optical system preferably satisfies, for example, the condition expressed by the following Inequality (8):

$$50 < v d 5 G \qquad ( 8 )$$

Where vd5G is an Abbe number of the single lens of the fifth lens group G5.

The condition expressed by this Inequality (8) defines a preferred range for the Abbe number of the lens of the fifth lens group G5. If vd5G were equal to or less than the lower limit set by this Inequality (8), then it would be difficult to compensate for various types of aberrations (e.g., chromatic aberration, among other things) with adequate balance struck.

To enhance the advantage described above, the condition expressed by the following Inequality (8a) is preferably satisfied:

$$54 < v d 5 G . \qquad ( 8 a )$$

The following Inequality (8b) sets a preferred upper limit for the Abbe number vd5G, of which the lower limit value is set by Inequality (8):

$$v d 5 G < 80 . \qquad ( 8 b )$$

If vd5G were equal to or greater than the upper limit set by this Inequality (8b), then it would be difficult to compensate for chromatic aberration sufficiently. In that case, the condition expressed by this Inequality (8b) is preferably satisfied with either the condition expressed by Inequality (8) or the condition expressed by Inequality (8a) satisfied.

To further enhance the advantage described above, at least one of the conditions expressed by the following Inequalities (8c) and (8d) is more preferably satisfied:

$$58 < vd 5 G \qquad ( 8 c )$$

$$vd 5 G < 64. \qquad ( 8 d )$$

The imaging optical system preferably satisfies, for example, the condition expressed by the following Inequality (9):

$$0.4 < ( 1 - β 4 \times β 4 ) \times β 4 r \times β 4 r < 1. \qquad ( 9 )$$

Where β4 is a lateral magnification of the fourth lens group G4 when the imaging optical system is in the infinity in-focus state; and β4r is a composite lateral magnification of all lenses, located closer to the image than the fourth lens group G4 is, of the imaging optical system when the imaging optical system is in the infinity in-focus state.

The condition expressed by this Inequality (9) defines preferred position sensitivity for the fourth lens group G4. If (1−β4×β4)×β4r×β4r were equal to or less than the lower limit set by this Inequality (9), then the fourth lens group G4 would move so significantly during focusing as to make it difficult to reduce the size of the lens system. If (1−β4×β4)×β4r×β4r were equal to or greater than the upper limit set by this Inequality (9), then the fourth lens group G4 would have so high position sensitivity as to make it difficult to perform control during focusing, which is unfavorable.

To enhance the advantage described above, at least one of the conditions expressed by the following Inequalities (9a) and (9b) is preferably satisfied:

$$0.5 < ( 1 - β 4 \times β 4 ) \times β 4 r \times β4 r \qquad ( 9 a )$$

$$( 1 - β 4 \times β 4 ) \times β 4 r \times β 4 r < 0.9 . \qquad ( 9 b )$$

To further enhance the advantage described above, at least one of the conditions expressed by the following Inequalities (9c) and (9d) is more preferably satisfied:

$$0.6 < ( 1 - β 4 \times β 4 ) \times β 4 r \times β4r \qquad ( 9 c )$$

$$( 1 - β 4 \times β 4 ) \times β 4 r \times β 4 r < 0.8 . \qquad ( 9 d )$$

In the imaging optical system, the first lens group G1 may include a single image blur compensation lens located closest to the image and configured to move perpendicularly to the optical axis. In that case, the imaging optical system preferably satisfies, for example, the condition expressed by the following Inequality (10):

$$0.2 \leq \vert ( 1 - β ) \times β r \vert \leq 10 \qquad ( 10 )$$

Where β is a lateral magnification of the image blur compensation lens when the imaging optical system is in the infinity in-focus state; and Br is a composite lateral magnification of all lenses, located closer to the image than the image blur compensation lens is, of the imaging optical system when the imaging optical system is in the infinity in-focus state.

The condition expressed by this Inequality (10) defines a preferred ratio of image shift to the magnitude of movement of the image blur compensation lens. Satisfying the condition expressed by this Inequality (10) enables compensating for image blur effectively while reducing the overall size of the imaging optical system.

If |(1−β)×βr| were less than the lower limit set by this Inequality (10), then the magnitude of movement of the image blur compensation lens required to shift the image to a predetermined degree would increase so significantly as to make it difficult to reduce the overall size of the imaging optical system. If |(1−β)×βr| were greater than the upper limit set by this Inequality (10), then the magnitude of movement of the image blur compensation lens required to shift the image to a predetermined degree would decrease so significantly as to demand high-precision control. In addition, in that case, the power of the image blur compensation lens would increase so significantly as to make it difficult to have compensation done as intended.

To enhance the advantage described above, at least one of the conditions expressed by the following Inequalities (10a) and (10b) is preferably satisfied:

$$0.3 \leq \vert ( 1 - β ) \times β r \vert \qquad ( 10 a )$$

$$\vert ( 1 - β ) \times β r \vert \leq 0.95 . \qquad ( 10 b )$$

To further enhance the advantage described above, at least one of the conditions expressed by the following Inequalities (10c) and (10d) is more preferably satisfied:

$$0.4 \leq \vert ( 1 - β ) \times β r \vert \qquad ( 10 c )$$

$$\vert ( 1 - β ) \times β r \vert \leq 0.9 . \qquad ( 10 d )$$

Furthermore, in the imaging optical system, the first lens group G1 may include a plurality of lenses. In that case, the plurality of lenses preferably includes: a lens having negative power and located closest to the object in the plurality of lenses: a lens having positive power and located second closest to the object in the plurality of lenses: a lens having positive power and located third closest to the object in the plurality of lenses; and a lens having negative power and located fourth closest to the object in the plurality of lenses.

This enables providing an imaging optical system in which various types of aberrations have been compensated for sufficiently over the entire focus range, although its overall size is small.

(Schematic Configuration for Image Capture Device to which First Embodiment is Applied)

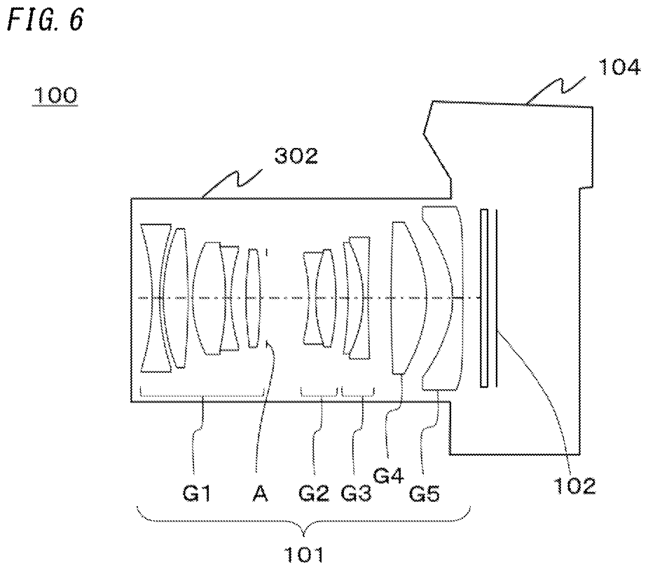

FIG. 6 illustrates a schematic configuration for an image capture device, to which the imaging optical system of the first embodiment is applied. Alternatively, the imaging optical system according to the second, third, fourth, or fifth embodiment is also applicable to the image capture device.

The image capture device 100 includes a housing 104, an image sensor 102, and the imaging optical system 101 according to the first embodiment. Specifically, the image capture device 100 may be implemented as a digital camera, for example.

The housing 104 includes a lens barrel 302. The lens barrel 302 holds the respective lens groups of the imaging optical system 101 and the aperture stop A.

The image sensor 102 is disposed at the image plane S of the imaging optical system 101 according to the first embodiment.

In the imaging optical system 101, to allow the second lens group G2 and the fourth lens group G4 to move while the imaging optical system 101 is focusing, a lens frame included in the lens barrel 302 is attached to, or engaged with, the respective lens groups.

To allow the second lens group G2 and the fourth lens group G4 to move while the imaging optical system 101 is focusing, the imaging optical system 101 includes an actuator and a lens frame to be controlled by either the image capture device 100 or a controller in the lens barrel 302.

This provides an image capture device with the ability to compensate for various types of aberrations sufficiently.

In the example described above, the imaging optical system according to the first embodiment is applied to a digital camera. However, this is only an example and should not be construed as limiting. Alternatively, the imaging optical system is also applicable to a surveillance camera, a smartphone, or any of various other types of image capture devices.

(Schematic Configuration for Camera System to which First Embodiment is Applied)

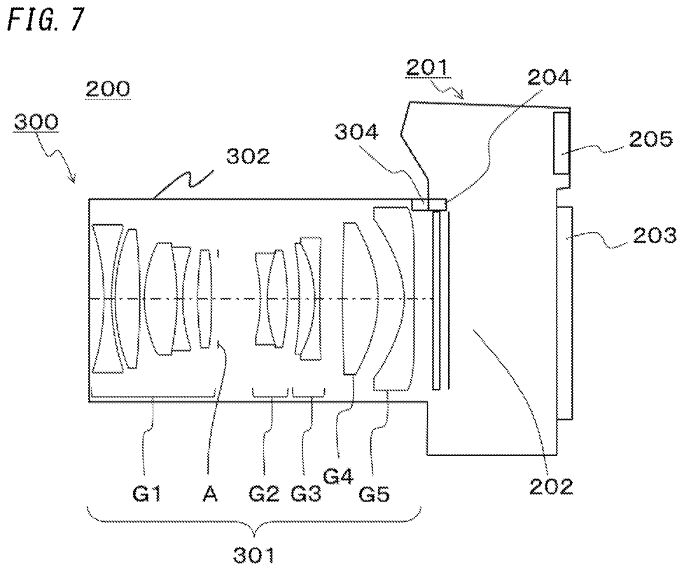

FIG. 7 illustrates a schematic configuration for a camera system, to which the imaging optical system of the first embodiment is applied. Alternatively, the imaging optical system according to the second, third, fourth, or fifth embodiment is also applicable to the camera system.

The camera system 200 includes a camera body 201 and an interchangeable lens unit 300 to be connected removably to the camera body 201.

The camera body 201 includes an image sensor 202, a monitor 203, a memory, a camera mount 204, and a viewfinder 205. The image sensor 202 receives an optical image formed by the imaging optical system 301 of the interchangeable lens unit 300 and transforms the optical image into an electrical image signal. The monitor 203 displays the image signal transformed by the image sensor 202. The memory stores the image signal.

The imaging optical system 301 of the interchangeable lens unit 300 is the imaging optical system according to the first embodiment.

The interchangeable lens unit 300 includes not only the imaging optical system 301 but also a lens barrel 302 and a lens mount 304. The lens barrel 302 holds the respective lens groups and aperture stop A of the imaging optical system 301. The lens mount 304 is configured to be connected removably to the camera mount 204 of the camera body 201.

In this manner, the camera mount 204 and the lens mount 304 are physically connected to each other. In addition, the camera mount 204 and the lens mount 304 also electrically connect together a controller in the camera body 201 and a controller in the interchangeable lens unit 300. That is to say, the camera mount 204 and the lens mount 304 also serve as interfaces that allow themselves to exchange signals with each other.

In the imaging optical system 301, to allow the respective lens frames that hold the second lens group G2 and the fourth lens group G4 to move while the imaging optical system 301 is focusing, a lens frame included in the lens barrel 302 is attached to, or engaged with, the respective lens groups.

To allow the second lens group G2 and the fourth lens group G4 to move while the imaging optical system 301 is focusing, the interchangeable lens unit 300, including the respective lens groups held by the lens barrel 302 and the camera body 201, has an actuator and a lens frame to be controlled by a controller in the interchangeable lens unit 300.

### (Examples of Numerical Values)

Next, exemplary sets of specific numerical values that were actually adopted in the imaging optical systems with the configurations according to the first, second, third, fourth, and fifth embodiments will be described. Note that in the tables showing these exemplary sets of numerical values, the length is expressed in millimeters (mm), the angle of view is expressed in degrees)(°, r indicates the radius of curvature, d indicates the surface interval, nd indicates a refractive index in response to a d-line, vd (also denoted as “vd”) indicates an Abbe number in response to a d-line, and a surface with an asterisk (*) is an aspheric surface. The aspheric shape is defined by the following Equation (1):

[symbol]

Where Z is the distance from a point on an aspheric surface, located at a height h as measured from the optical axis, to a tangent plane defined with respect to the vertex of the aspheric surface, h is the height as measured from the optical axis, r is the radius of curvature of the vertex, K is a conic constant, and An is an n^{th} order aspheric surface coefficient.

FIGS. 1B, 2B, 3B, 4B, and 5B are longitudinal aberration diagrams showing what state the imaging optical systems according to the first, second, third, fourth, and fifth embodiments assume.

In each longitudinal aberration diagram, portion (a) shows the longitudinal aberrations in the infinity in-focus state, portion (b) shows the longitudinal aberrations at a middle position, portion (c) shows the longitudinal aberrations in the close-object in-focus state. Each of portions (a), (b), and (c) of these longitudinal aberration diagrams shows spherical aberration (SA (mm)), astigmatism (AST (mm)), and distortion (DIS (%)) in this order from left to right. In each spherical aberration diagram, the ordinate indicates the F number (designated by “F” on the drawings), the solid curve indicates a characteristic in response to a d-line, the shorter dashed curve indicates a characteristic in response to an F-line, and the longer dashed curve indicates a characteristic in response to a C-line. In each astigmatism diagram, the ordinate indicates the image height (designated by “H” on the drawings), the solid curve indicates a characteristic with respect to a sagittal plane (designated by “s” on the drawings), and the dotted curve indicates a characteristic with respect to a meridional plane (designated by “m” on the drawings). Furthermore, in each distortion diagram, the ordinate indicates the image height (designated by “H” on the drawings).

FIGS. 1C, 2C, 3C, 4C, and 5C are lateral aberration diagrams showing what state the imaging optical systems according to the first, second, third, fourth, and fifth embodiments assume in the infinity in-focus state.

In each lateral aberration diagram, the upper three aberration diagrams represent a basic state where no image blur compensation is performed when the imaging optical system is in the infinity in-focus state. On the other hand, the lower three aberration diagrams represent an image blur compensated state where the image blur compensation lens group is moved to a predetermined degree perpendicularly to the optical axis when the imaging optical system is in the infinity in-focus state. In the three lateral aberration diagrams representing the basic state, the upper graph shows lateral aberration at an image point corresponding to 70% of the maximum image height. The middle graph shows the lateral aberration at an axial image point. The lower graph shows lateral aberration at an image point corresponding to −70% of the maximum image height. In the three lateral aberration diagrams representing the image blur compensated state, the upper graph shows lateral aberration at an image point corresponding to 70% of the maximum image height. The middle graph shows lateral aberration at an axial image point. The lower graph shows lateral aberration at an image point corresponding to −70% of the maximum image height. Also, in each lateral aberration diagram, the abscissa indicates the distance from a principal ray on the pupil plane. The solid curve indicates a characteristic in response to a d-line. The shorter dashed curve indicates a characteristic in response to an F-line. The longer dashed curve indicates a characteristic in response to a C-line.

Note that in the imaging optical systems according to the respective examples of numerical values, the magnitudes of movement of the image blur compensation lens group in a direction perpendicular to the optical axis in the image blur compensated state are as follows:
First example of numerical values: 0.401 mm
Second example of numerical values: 0.412 mm
Third example of numerical values: 0.410 mm
Fourth example of numerical values: 0.406 mm
Fifth example of numerical values: 0.270 mm

In the infinity in-focus state, the magnitude of image eccentricity in a situation where the imaging optical system is tilted to a predetermined degree is equal to the magnitude of image eccentricity in a situation where the image blur compensation lens group makes parallel displacement by a distance represented by any of these numerical values in a direction perpendicular to the optical axis.

As can be seen from these lateral aberration diagrams, the lateral aberration at the axial image point has a sufficient degree of symmetry. It can also be seen that comparing the lateral aberration at an image point corresponding to +70% of the maximum image height with the lateral aberration at an image point corresponding to −70% of the maximum image height in the basic state, their degrees of curvature are both small and their aberration curves have an approximately equal tilt, and therefore, their eccentricity coma aberration and eccentricity astigmatism are both insignificant. This means that even in the image blur compensated state, sufficiently good imaging performance is achieved. In addition, supposing the imaging optical systems have the same image blur compensation angle, as the focal length of the entire imaging optical system shortens, the magnitude of parallel displacement required for image blur compensation decreases. This allows the image blur compensation to be done to a sufficient degree at any focus position with respect to a predetermined image blur compensation angle without causing a decline in imaging performance.

### (First Example of Numerical Values)

Following is a first exemplary set of numerical values for the imaging optical system corresponding to the first embodiment shown in FIG. 1A. Specifically, as the first example of numerical values for the imaging optical system, surface data is shown in Table 1A, aspheric surface data is shown in Table 1B, and various types of data are shown in Tables 1C-1E.

TABLE 1A
(Surface data)

| Surface No. | r | d | nd | vd |
|---|---|---|---|---|
| Object surface | ∞ | Variable | | |
| 1 | −48.24880 | 1.50000 | 1.64769 | 33.8 |
| 2 | 44.73430 | 0.72880 | | |
| 3 | 37.97200 | 5.00000 | 2.00069 | 25.5 |
| 4 | −131.50720 | 0.90000 | | |
| 5 | 25.17960 | 6.60000 | 1.59282 | 68.6 |
| 6 | −47.51790 | 0.01000 | 1.56732 | 42.8 |
| 7 | −47.51790 | 1.10000 | 1.76182 | 26.6 |
| 8 | 30.77150 | 2.99140 | | |
| 9* | 54.81860 | 2.80000 | 1.58660 | 59.0 |
| 10* | −129.05710 | 1.34230 | | |
| 11 (Aperture) | ∞ | Variable | | |
| 12* | −34.79670 | 1.40000 | 1.68948 | 31.0 |
| 13 | 27.95970 | 0.01000 | 1.56732 | 42.8 |
| 14 | 27.95970 | 4.00000 | 1.95375 | 32.3 |
| 15 | −47.70420 | Variable | | |
| 16 | −69.07570 | 3.10000 | 1.90366 | 31.3 |
| 17 | −23.36060 | 0.01000 | 1.56732 | 42.8 |
| 18 | −23.36060 | 1.00000 | 1.69895 | 30.1 |
| 19 | 306.94780 | Variable | | |
| 20* | 202.64210 | 7.14970 | 1.55332 | 71.7 |
| 21* | −24.51590 | Variable | | |
| 22* | −17.16680 | 2.00000 | 1.58660 | 59.0 |
| 23* | −295.00000 | 3.60000 | | |
| 24 | ∞ | 1.40000 | 1.51680 | 64.2 |
| 25 | ∞ | 1.00000 | | |
| 26 | ∞ | BF | | |
| Image plane | ∞ | | | |

TABLE 1B
(Aspheric surface data)
9^{th} surface
K = 0.00000E+00, A4 = −1.30306E−05, A6 = −5.62107E−08, A8 = −3.60682E−10
A10 = 8.61029E−14, A12 = −7.87986E−14, A14 = 5.22901E−17
10^{th} surface
K = 0.00000E+00, A4 = −9.82247E−06, A6 = −9.90962E−09, A8 = −2.51292E−09
A10 = 3.89661E−11, A12 = −4.70452E−13, A14 = 1.70621E−15
12^{th} surface
K = −4.20325E−01, A4 = −2.20963E−05, A6 = −1.90668E−08, A8 = −1.28958E−09
A10 = 1.02111E−11, A12 = 0.00000E+00, A14 = 0.00000E+00
20^{th} surface
K = 0.00000E+00, A4 = −1.18748E−05, A6 = 6.25689E−08, A8 = −1.36411E−10
A10 = 7.15711E−14, A12 = −3.29562E−17, A14 = −1.87905E−18
21^{st} surface
K = 0.00000E+00, A4 = 3.35820E−06, A6 = 1.04068E−07, A8 = −6.34208E−10
A10 = 4.09992E−12, A12 = −1.28044E−14, A14 = 1.19979E−17
22^{nd} surface
K = −2.75865E−01, A4 = 7.31746E−05, A6 = −2.58094E−07, A8 = 7.84314E−10
A10 = 2.62197E−13, A12 = −3.52305E−15, A14 = 0.00000E+00
23^{rd} surface
K = 0.00000E+00, A4 = 3.22163E−05, A6 = −2.53939E−07, A8 = 7.10332E−10
A10 = −8.86821E−13, A12 = 0.00000E+00, A14 = 0.00000E+00

TABLE 1C
(Various types of data at respective focus positions)

| | Infinity | Middle | Close-object |
|---|---|---|---|
| Focal length | 41.7102 | 39.5110 | 36.8281 |
| F number | 2.06002 | 2.03508 | 2.01362 |
| Angle of view | 27.4964 | 27.8222 | 28.1646 |
| Image height | 20.0000 | 20.0000 | 20.0000 |
| Total lens length | 68.3749 | 68.3748 | 68.3749 |
| BF | 0.00000 | 0.00000 | 0.00000 |
| d0 | ∞ | 1331.6250 | 531.6251 |
| d11 | 8.5000 | 7.6379 | 6.4983 |
| d15 | 2.3984 | 3.2604 | 4.4001 |
| d19 | 4.5634 | 3.3774 | 1.8105 |
| d21 | 5.2709 | 6.4569 | 8.0238 |
| Entrance pupil position | 18.4211 | 18.4211 | 18.4211 |
| Exit pupil position | −29.2267 | −28.3987 | −27.3813 |
| Anterior principal point | 0.6174 | 0.5544 | 0.3280 |
| Posterior principal point | 26.6705 | 27.6729 | 28.8610 |

TABLE 1D
(Data about single lenses)

| Lens | Start surface | Focal length |
|---|---|---|
| 1 | 1 | −35.6132 |
| 2 | 3 | 29.8849 |
| 3 | 5 | 28.7335 |
| 4 | 7 | −24.3681 |
| 5 | 9 | 65.9620 |
| 6 | 12 | −22.2820 |
| 7 | 14 | 18.9724 |
| 8 | 16 | 37.8430 |
| 9 | 18 | −31.0201 |
| 10 | 20 | 39.9734 |
| 11 | 22 | −31.1560 |

TABLE 1E
(Data about lens groups)

| Group | Start surface | Focal length |
|---|---|---|
| 1 | 1 | 51.98012 |
| 2 | 12 | 94.90715 |
| 3 | 16 | −154.71471 |
| 4 | 20 | 39.97336 |
| 5 | 22 | −31.15596 |

### (Second Example of Numerical Values)

Following is a second exemplary set of numerical values for the imaging optical system corresponding to the second embodiment shown in FIG. 2A. Specifically, as the second example of numerical values for the imaging optical system, surface data is shown in Table 2A, aspheric surface data is shown in Table 2B, and various types of data are shown in Tables 2C-2E.

TABLE 2A
(Surface data)

| Surface No. | r | d | nd | vd |
|---|---|---|---|---|
| Object surface | ∞ | Variable | | |
| 1 | −47.27120 | 1.50000 | 1.64769 | 33.8 |
| 2 | 43.35010 | 1.13810 | | |
| 3 | 37.84250 | 5.13070 | 2.00069 | 25.5 |
| 4 | −109.34490 | 0.30000 | | |
| 5 | 24.66250 | 6.33950 | 1.59282 | 68.6 |
| 6 | −44.99310 | 0.01000 | 1.56732 | 42.8 |
| 7 | −44.99310 | 1.10000 | 1.76182 | 26.6 |
| 8 | 29.03040 | 2.87540 | | |
| 9* | 49.87530 | 2.80000 | 1.58660 | 59.0 |
| 10* | −204.73780 | 1.74550 | | |
| 11 (Aperture) | ∞ | Variable | | |
| 12* | −29.49050 | 1.40000 | 1.68948 | 31.0 |
| 13 | 33.59850 | 0.01000 | 1.56732 | 42.8 |
| 14 | 33.59850 | 3.98870 | 1.95375 | 32.3 |
| 15 | −39.48390 | Variable | | |
| 16 | −121.42970 | 2.80000 | 1.90366 | 31.3 |
| 17 | −30.03790 | 0.01000 | 1.56732 | 42.8 |
| 18 | −30.03790 | 1.00000 | 1.69895 | 30.1 |
| 19 | 139.37220 | Variable | | |
| 20* | 120.99910 | 7.84260 | 1.49710 | 81.6 |
| 21* | −24.03830 | Variable | | |
| 22* | −17.55440 | 2.00000 | 1.58660 | 59.0 |
| 23* | −555.05190 | 3.60000 | | |
| 24 | ∞ | 1.40000 | 1.51680 | 64.2 |
| 25 | ∞ | 1.00000 | | |
| 26 | ∞ | BF | | |
| Image plane | ∞ | | | |

TABLE 2B
(Aspheric surface data)
9^{th} surface
K = 0.00000E+00, A4 = −4.68166E−06, A6 = 1.69614E−08, A8 = −3.30307E−10
A10 = 3.92522E−12, A12 = −9.10972E−14, A14 = 2.66210E−16
10^{th} surface
K = 0.00000E+00, A4 = −8.61855E−07, A6 = 6.00961E−08, A8 = −2.25834E−09
A10 = 3.77021E−11, A12 = −4.29350E−13, A14 = 1.62997E−15
12^{th} surface
K = −3.54281E−01, A4 = −2.22970E−05, A6 = −2.35367E−08, A8 = −1.15351E−09
A10 = 9.21922E−12, A12 = 0.00000E+00, A14 = 0.00000E+00
20^{th} surface
K = 0.00000E+00, A4 = −8.85815E−06, A6 = 6.38274E−08, A8 = −2.23000E−10
A10 = 4.04212E−13, A12 = −5.58470E−16, A14 = −3.96775E−18
21^{st} surface
K = 0.00000E+00, A4 = 5.56661E−06, A6 = 1.04165E−07, A8 = −6.28585E−10
A10 = 3.80047E−12, A12 = −1.10689E−14, A14 = 6.48773E−18
22^{nd} surface
K = −5.09328E−01, A4 = 5.38576E−05, A6 = −1.78278E−07, A8 = 5.02684E−10
A10 = 2.72567E−13, A12 = −3.07869E−15, A14 = 0.00000E+00
23^{rd} surface
K = 0.00000E+00, A4 = 1.99308E−05, A6 = −1.75668E−07, A8 = 4.94739E−10
A10 = −6.58493E−13, A12 = 0.00000E+00, A14 = 0.00000E+00

TABLE 2C
(Various types of data at respective focus positions)

| | Infinity | Middle | Close-object |
|---|---|---|---|
| Focal length | 41.6884 | 39.4489 | 36.7360 |
| F number | 2.06001 | 2.03372 | 2.01127 |
| Angle of view | 27.4897 | 27.8453 | 28.2094 |
| Image height | 20.0000 | 20.0000 | 20.0000 |
| Total lens length | 68.3449 | 68.3449 | 68.3448 |
| BF | 0.00000 | 0.00000 | 0.00000 |
| d0 | ∞ | 1331.6550 | 531.6551 |
| d11 | 8.8535 | 7.9489 | 6.7603 |
| d15 | 1.7897 | 2.6943 | 3.8829 |
| d19 | 4.6739 | 3.4427 | 1.8283 |
| d21 | 5.0373 | 6.2685 | 7.8828 |
| Entrance pupil position | 18.1602 | 18.1602 | 18.1602 |
| Exit pupil position | −28.9682 | −28.1366 | −27.1231 |
| Anterior principal point | −0.1313 | −0.1364 | −0.2992 |
| Posterior principal point | 26.6634 | 27.7090 | 28.9358 |

TABLE 2D
(Data about single lenses)

| Lens | Start surface | Focal length |
|---|---|---|
| 1 | 1 | −34.6875 |
| 2 | 3 | 28.5920 |
| 3 | 5 | 27.8142 |
| 4 | 7 | −23.0142 |
| 5 | 9 | 68.6481 |
| 6 | 12 | −22.5741 |
| 7 | 14 | 19.5534 |
| 8 | 16 | 43.5324 |
| 9 | 18 | −35.2702 |
| 10 | 20 | 41.0798 |
| 11 | 22 | −30.9455 |

TABLE 2E
(Data about lens groups)

| Group | Start surface | Focal length |
|---|---|---|
| 1 | 1 | 51.60842 |
| 2 | 12 | 99.74965 |
| 3 | 16 | −177.82625 |
| 4 | 20 | 41.07976 |
| 5 | 22 | −30.94550 |

### (Third Example of Numerical Values)

Following is a third exemplary set of numerical values for the imaging optical system corresponding to the third embodiment shown in FIG. 3A. Specifically, as the third example of numerical values for the imaging optical system, surface data is shown in Table 3A, aspheric surface data is shown in Table 3B, and various types of data are shown in Tables 3C-3E.

TABLE 3A
(Surface data)

| Surface No. | r | d | nd | vd |
|---|---|---|---|---|
| Object surface | ∞ | Variable | | |
| 1 | −50.47670 | 1.50000 | 1.60342 | 38.0 |
| 2 | 35.30580 | 0.89820 | | |
| 3 | 32.54950 | 5.93800 | 2.00100 | 29.1 |
| 4 | −140.64290 | 0.46440 | | |
| 5 | 26.05100 | 7.17530 | 1.49700 | 81.6 |
| 6 | −43.26860 | 0.01000 | 1.56732 | 42.8 |
| 7 | −43.26860 | 1.10000 | 1.76182 | 26.6 |
| 8 | 35.81630 | 1.81420 | | |
| 9* | 60.99390 | 2.80000 | 1.58660 | 59.0 |
| 10* | −108.35630 | 1.29580 | | |
| 11 (Aperture) | ∞ | Variable | | |
| 12* | −34.42470 | 1.40000 | 1.68948 | 31.0 |
| 13 | 29.94870 | 0.01000 | 1.56732 | 42.8 |
| 14 | 29.94870 | 4.00000 | 1.95375 | 32.3 |
| 15 | −46.62520 | Variable | | |
| 16 | −97.21390 | 3.10000 | 1.90366 | 31.3 |
| 17 | −25.97170 | 0.01000 | 1.56732 | 42.8 |
| 18 | −25.97170 | 1.00000 | 1.69895 | 30.1 |
| 19 | 250.89340 | Variable | | |
| 20* | 229.22650 | 6.93660 | 1.55332 | 71.7 |
| 21* | −25.56050 | Variable | | |
| 22* | −17.10980 | 2.00000 | 1.58660 | 59.0 |
| 23* | −705.68610 | 3.60000 | | |
| 24 | ∞ | 1.40000 | 1.51680 | 64.2 |
| 25 | ∞ | 1.00000 | | |
| 26 | ∞ | BF | | |
| Image plane | ∞ | | | |

TABLE 3B
(Aspheric surface data)

9^{th} surface
K = 0.00000E+00, A4 = −1.15917E−05, A6 = −7.06701E−08, A8 = −2.92537E−10
A10 = 1.83000E−12, A12 = −1.18168E−13, A14 = 3.86396E−16
10^{th} surface
K = 0.00000E+00, A4 = −8.45388E−06, A6 = −2.65783E−08, A8 = −2.26254E−09
A10 = 3.64884E−11, A12 = −4.45535E−13, A14 = 1.70602E−15
12^{th} surface
K = 1.01706E−01, A4 = −2.14456E−05, A6 = −1.82712E−08, A8 = −1.10860E−09
A10 = 8.42294E−12, A12 = 0.00000E+00, A14 = 0.00000E+00
20^{th} surface
K = 0.00000E+00, A4 = −8.86483E−06, A6 = 6.87803E−08, A8 = −2.16144E−10
A10 = 4.56678E−13, A12 = −1.06364E−15, A14 = −1.74491E−18
21^{st} surface
K = 0.00000E+00, A4 = 3.76656E−06, A6 = 1.05629E−07, A8 = −5.51680E−10
A10 = 3.28466E−12, A12 = −1.03646E−14, A14 = 8.28818E−18
22^{nd} surface
K = −1.60121E−01, A4 = 6.49077E−05, A6 = −1.06703E−07, A8 = 4.03786E−10
A10 = −3.40656E−13, A12 = −1.86476E−16, A14 = 0.00000E+00
23^{rd} surface
K = 0.00000E+00, A4 = 1.37251E−05, A6 = −1.07707E−07, A8 = 2.77280E−10
A10 = −4.44651E−13, A12 = 0.00000E+00, A14 = 0.00000E+00

TABLE 3C
(Various types of data at respective focus positions)

| | Infinity | Middle | Close-object |
|---|---|---|---|
| Focal length | 41.6988 | 39.4777 | 36.7679 |
| F number | 2.06023 | 2.03704 | 2.01780 |
| Angle of view | 27.5190 | 27.8220 | 28.1322 |
| Image height | 20.0000 | 20.0000 | 20.0000 |
| Total lens length | 68.5662 | 68.5663 | 68.5663 |
| BF | 0.00000 | 0.00000 | 0.00000 |
| d0 | ∞ | 1331.4336 | 531.4337 |
| d11 | 8.7198 | 7.8237 | 6.6377 |
| d15 | 2.1035 | 2.9997 | 4.1857 |
| d19 | 4.6928 | 3.4822 | 1.8811 |
| d21 | 5.5976 | 6.8082 | 8.4093 |
| Entrance pupil position | 17.9461 | 17.9461 | 17.9461 |
| Exit pupil position | −28.3712 | −27.6190 | −26.6923 |
| Anterior principal point | −1.6480 | −1.5595 | −1.6057 |
| Posterior principal point | 26.8648 | 27.8921 | 29.1098 |

TABLE 3D
(Data about single lenses)

| Lens | Start surface | Focal length |
|---|---|---|
| 1 | 1 | −34.2035 |
| 2 | 3 | 26.8665 |
| 3 | 5 | 33.8824 |
| 4 | 7 | −25.5684 |
| 5 | 9 | 66.9382 |
| 6 | 12 | −23.0241 |
| 7 | 14 | 19.6202 |
| 8 | 16 | 38.4245 |
| 9 | 18 | −33.6226 |
| 10 | 20 | 41.9676 |
| 11 | 22 | −29.9245 |

TABLE 3E
(Data about lens groups)

| Group | Start surface | Focal length |
|---|---|---|
| 1 | 1 | 54.23166 |
| 2 | 12 | 97.98983 |
| 3 | 16 | −242.47228 |
| 4 | 20 | 41.96756 |
| 5 | 22 | −29.92454 |

### (Fourth Example of Numerical Values)

Following is a fourth exemplary set of numerical values for the imaging optical system corresponding to the fourth embodiment shown in FIG. 4A. Specifically, as the fourth example of numerical values for the imaging optical system, surface data is shown in Table 4A, aspheric surface data is shown in Table 4B, and various types of data are shown in Tables 4C-4E.

TABLE 4A
(Surface data)

| Surface No. | r | d | nd | vd |
|---|---|---|---|---|
| Object surface | ∞ | Variable | | |
| 1 | −43.65260 | 1.40000 | 1.68893 | 31.2 |
| 2 | 26.65110 | 0.01000 | 1.56732 | 42.8 |
| 3 | 26.65110 | 6.53020 | 2.00069 | 25.5 |
| 4 | −91.74250 | 0.30000 | | |
| 5 | 25.87580 | 7.09390 | 1.59282 | 68.6 |
| 6 | −34.37440 | 0.01000 | 1.56732 | 42.8 |
| 7 | −34.37440 | 1.00000 | 1.75520 | 27.5 |
| 8 | 31.69350 | 2.01070 | | |
| 9* | 60.40430 | 2.80000 | 1.58660 | 59.0 |
| 10* | −108.15820 | 1.26900 | | |
| 11 (Aperture) | ∞ | Variable | | |
| 12* | −32.12080 | 1.30000 | 1.68948 | 31.0 |
| 13 | 29.82650 | 0.01000 | 1.56732 | 42.8 |
| 14 | 29.82650 | 4.44790 | 1.95375 | 32.3 |
| 15 | −43.85400 | Variable | | |
| 16 | −83.24220 | 2.80000 | 1.90366 | 31.3 |
| 17 | −28.86210 | 0.01000 | 1.56732 | 42.8 |
| 18 | −28.86210 | 1.00000 | 1.69895 | 30.1 |
| 19 | ∞ | Variable | | |
| 20* | 297.41410 | 6.63640 | 1.55332 | 71.7 |
| 21* | −26.31260 | Variable | | |
| 22* | −17.97840 | 2.00000 | 1.58660 | 59.0 |
| 23* | −545.42630 | 3.60000 | | |
| 24 | ∞ | 1.40000 | 1.51680 | 64.2 |
| 25 | ∞ | 1.00000 | | |
| 26 | ∞ | BF | | |
| Image plane | ∞ | | | |

TABLE 4B
(Aspheric surface data)

9^{th} surface
K = 0.00000E+00, A4 = −1.60858E−05, A6 = 2.04423E−08, A8 = −5.00399E−09
A10 = 1.03452E−10, A12 = −1.18145E−12, A14 = 4.70808E−15
10^{th} surface
K = 0.00000E+00, A4 = −1.23340E−05, A6 = 1.68062E−08, A8 = −5.32458E−09
A10 = 1.11190E−10, A12 = −1.30069E−12, A14 = 5.44695E−15
12^{th} surface
K = −3.23019E−01, A4 = −1.91896E−05, A6 = −5.77786E−08, A8 = 1.42084E−10
A10 = −9.28101E−13, A12 = 0.00000E+00, A14 = 0.00000E+00
20^{th} surface
K = 0.00000E+00, A4 = −7.35139E−06, A6 = 6.37903E−08, A8 = −7.12465E−11
A10 = −3.77501E−13, A12 = 0.00000E+00, A14 = 0.00000E+00
21^{st} surface
K = 0.00000E+00, A4 = 8.02250E−06, A6 = 2.91337E−08, A8 = 3.59713E−10
A10 = −1.72914E−12, A12 = 2.66920E−15, A14 = −4.67029E−18
22^{nd} surface
K = −1.30292E−02, A4 = 6.94180E−05, A6 = −2.39958E−07, A8 = 1.46294E−09
A10 = −3.83909E−12, A12 = 4.67719E−15, A14 = 0.00000E+00
23^{rd} surface
K = 0.00000E+00, A4 = 1.91303E−05, A6 = −1.64342E−07, A8 = 5.01200E−10
A10 = −7.12839E−13, A12 = 0.00000E+00, A14 = 0.00000E+00

TABLE 4C
(Various types of data at respective focus positions)

| | Infinity | Middle | Close-object |
|---|---|---|---|
| Focal length | 41.7045 | 39.5377 | 36.8756 |
| F number | 2.06000 | 2.03625 | 2.01585 |
| Angle of view | 27.5564 | 27.8536 | 28.1546 |
| Image height | 20.0000 | 20.0000 | 20.0000 |
| Total lens length | 68.3423 | 68.3423 | 68.3423 |
| BF | 0.00000 | 0.00000 | 0.00000 |
| d0 | ∞ | 1331.6573 | 531.6573 |
| d11 | 9.5705 | 8.4670 | 7.0370 |
| d15 | 1.8806 | 2.9841 | 4.4141 |
| d19 | 4.6412 | 3.4424 | 1.8361 |
| d21 | 5.6219 | 6.8207 | 8.4270 |
| Entrance pupil position | 16.9086 | 16.9086 | 16.9086 |
| Exit pupil position | −29.5266 | −28.6900 | −27.6624 |
| Anterior principal point | −0.2712 | −0.3964 | −0.6825 |
| Posterior principal point | 26.6482 | 27.6156 | 28.7702 |

TABLE 4D
(Data about single lenses)

| Lens | Start surface | Focal length |
|---|---|---|
| 1 | 1 | −23.8264 |
| 2 | 3 | 21.2230 |
| 3 | 5 | 26.0439 |
| 4 | 7 | −21.6937 |
| 5 | 9 | 66.4811 |
| 6 | 12 | −22.2403 |
| 7 | 14 | 19.1786 |
| 8 | 16 | 47.7243 |
| 9 | 18 | −41.2936 |
| 10 | 20 | 44.0103 |
| 11 | 22 | −31.7375 |

TABLE 4E
(Data about lens groups)

| Group | Start surface | Focal length |
|---|---|---|
| 1 | 1 | 53.64266 |
| 2 | 12 | 97.35970 |
| 3 | 16 | −273.98564 |
| 4 | 20 | 44.01029 |
| 5 | 22 | −31.73754 |

### (Fifth Example of Numerical Values)

Following is a fifth exemplary set of numerical values for the imaging optical system corresponding to the fifth embodiment shown in FIG. 5A. Specifically, as the fifth example of numerical values for the imaging optical system, surface data is shown in Table 5A, aspheric surface data is shown in Table 5B, and various types of data are shown in Tables 5C-5E.

TABLE 5A
(Surface data)

| Surface No. | r | d | nd | vd |
|---|---|---|---|---|
| Object surface | ∞ | Variable | | |
| 1 | −48.02990 | 1.50000 | 1.75520 | 27.5 |
| 2 | 568.51760 | 1.07310 | | |
| 3 | 56.97520 | 4.20620 | 1.92286 | 20.9 |
| 4 | −109.63940 | 0.30000 | | |
| 5 | 27.44170 | 5.18510 | 1.83481 | 42.7 |
| 6 | −52.64140 | 0.01000 | 1.56732 | 42.8 |
| 7 | −52.64140 | 1.20000 | 1.85451 | 25.2 |
| 8 | 25.72470 | 2.52950 | | |
| 9 | −128.46330 | 1.40000 | 1.73037 | 32.2 |
| 10 | 137.75100 | 1.00000 | | |
| 11* | 38.05700 | 3.20000 | 1.58660 | 59.0 |
| 12* | −81.01800 | 1.30230 | | |
| 13 (Aperture) | ∞ | Variable | | |
| 14 | −30.99460 | 0.70000 | 1.60342 | 38.0 |
| 15 | 25.85030 | 0.01000 | 1.56732 | 42.8 |
| 16 | 25.85030 | 4.50000 | 1.85135 | 40.1 |
| 17* | −47.12150 | Variable | | |
| 18 | −103.05430 | 4.28320 | 1.90043 | 37.4 |
| 19 | −20.33420 | 0.01000 | 1.56732 | 42.8 |
| 20 | −20.33420 | 1.30000 | 1.72047 | 34.7 |
| 21 | 193.40840 | Variable | | |
| 22* | 140.05110 | 6.90570 | 1.55332 | 71.7 |
| 23* | −24.83730 | Variable | | |
| 24* | −15.71470 | 2.20000 | 1.58660 | 59.0 |
| 25* | −300.00000 | 3.60240 | | |
| 26 | ∞ | 1.40000 | 1.51680 | 64.2 |
| 27 | ∞ | 1.00000 | | |
| 28 | ∞ | BF | | |
| Image plane | ∞ | | | |

TABLE 5B
(Aspheric surface data)

11^{th} surface
K = 0.00000E+00, A4 = −1.00030E−05, A6 = −1.33677E−07, A8 = 1.11367E−09
A10 = −2.04431E−11, A12 = 0.00000E+00, A14 = 0.00000E+00
12^{th} surface
K = 0.00000E+00, A4 = −3.88812E−06, A6 = −1.03022E−07, A8 = 1.95311E−10
A10 = −1.40234E−11, A12 = 0.00000E+00, A14 = 0.00000E+00
17^{th} surface
K = 0.00000E+00, A4 = 1.59705E−05, A6 = −4.79860E−08, A8 = 1.66998E−09
A10 = −2.49997E−11, A12 = 1.92386E−13, A14 = −5.99899E−16
22^{nd} surface
K = 0.00000E+00, A4 = −8.93685E−06, A6 = 1.76038E−08, A8 = 2.45741E−10
A10 = −3.19128E−12, A12 = 1.42142E−14, A14 = −2.40447E−17
23^{rd} surface
K = 0.00000E+00, A4 = 9.76040E−06, A6 = −4.21729E−08, A8 = 1.10960E−09
A10 = −8.18967E−12, A12 = 2.93458E−14, A14 = −4.23199E−17
24^{th} surface
K = −3.25332E−01, A4 = 8.52450E−05, A6 = −2.84691E−07, A8 = 9.42875E−10
A10 = −3.38094E−13, A12 = −1.90682E−15, A14 = 0.00000E+00
25^{th} surface
K = 0.00000E+00, A4 = 2.91594E−05, A6 = −2.12196E−07, A8 = 5.51632E−10
A10 = −6.90522E−13, A12 = 0.00000E+00, A14 = 0.00000E+00

TABLE 5C
(Various types of data at respective focus positions)

| | Infinity | Middle | Close-object |
|---|---|---|---|
| Focal length | 41.7098 | 39.4000 | 36.6012 |
| F number | 2.06022 | 2.03133 | 2.00429 |
| Angle of view | 27.3845 | 27.8040 | 28.2733 |
| Image height | 20.0000 | 20.0000 | 20.0000 |
| Total lens length | 68.4029 | 68.4029 | 68.4030 |
| BF | 0.00000 | 0.00000 | 0.00000 |
| d0 | ∞ | 1331.5970 | 531.5972 |
| d13 | 9.2823 | 8.0963 | 6.6338 |
| d17 | 1.9859 | 3.1718 | 4.6344 |
| d21 | 4.1851 | 3.0379 | 1.5000 |
| d23 | 4.1321 | 5.2794 | 6.8173 |
| Entrance pupil position | 18.3903 | 18.3903 | 18.3903 |
| Exit pupil position | −28.6850 | −27.8765 | −26.8846 |
| Anterior principal point | −0.5433 | −0.3956 | −0.3516 |
| Posterior principal point | 26.6956 | 27.8057 | 29.1234 |

TABLE 5D
(Data about single lenses)

| Lens | Start surface | Focal length |
|---|---|---|
| 1 | 1 | −58.5831 |
| 2 | 3 | 41.1242 |
| 3 | 5 | 22.2637 |
| 4 | 7 | −20.0808 |
| 5 | 9 | −90.8105 |
| 6 | 11 | 44.5850 |
| 7 | 14 | −23.2505 |
| 8 | 16 | 20.1798 |
| 9 | 18 | 27.4604 |
| 10 | 20 | −25.4737 |
| 11 | 22 | 38.7038 |
| 12 | 24 | −28.3514 |

TABLE 5E
(Data about lens groups)

| Group | Start surface | Focal length |
|---|---|---|
| 1 | 1 | 51.16432 |
| 2 | 14 | 112.88568 |
| 3 | 18 | −284.90279 |
| 4 | 22 | 38.70376 |
| 5 | 24 | −28.35135 |

### (Values Corresponding to Inequalities)

Values applicable to the Inequalities (1) to (10) in the respective examples of numerical values are shown in the following Table 1

TABLE 1

| Inequality | | Ex. 1 | Ex. 2 | Ex. 3 | Ex. 4 | Ex. 5 |
|---|---|---|---|---|---|---|
| (1) | f1/f | 1.25 | 1.24 | 1.30 | 1.29 | 1.23 |
| (2) | \| f5/f \| | 0.75 | 0.74 | 0.72 | 0.76 | 0.68 |
| (3) | f2/f4 | 2.37 | 2.43 | 2.33 | 2.21 | 2.92 |
| (4) | BF/Y | 0.30 | 0.30 | 0.30 | 0.30 | 0.30 |
| (5) | TL/Y | 3.42 | 3.42 | 3.43 | 3.42 | 3.42 |
| (6) | nd2Gp | 1.95375 | 1.95375 | 1.95375 | 1.95375 | 1.85135 |
| (7) | vd4G | 71.68 | 81.56 | 71.68 | 71.68 | 71.68 |
| (8) | vd5G | 59.01 | 59.01 | 59.01 | 59.01 | 59.01 |
| (9) | (1 − β4 × β4) × β4r × β4r | 0.72 | 0.72 | 0.72 | 0.67 | 0.72 |
| (10) | \| (1 − β) × βr \| | 0.54 | 0.53 | 0.53 | 0.54 | 0.81 |

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

### INDUSTRIAL APPLICABILITY

The imaging optical system according to the present disclosure is applicable to various types of cameras including digital still cameras, lens interchangeable digital cameras, digital camcorders, cameras for cellphones and smartphones, and cameras for personal digital assistants (PDAs), surveillance cameras for surveillance systems, Web cameras, and onboard cameras. Among other things, the present disclosure is particularly effectively applicable as an imaging optical system for digital still camera systems, digital camcorder systems, and other camera systems that require high image quality.

1. An imaging optical system consisting of:
a first lens group having positive power;
an aperture stop;
a second lens group having positive power;
a third lens group having negative power;
a fourth lens group having positive power; and
a fifth lens group having negative power;
the first lens group, the aperture stop, the second lens group, the third lens group, the fourth lens group, and the fifth lens group being arranged in this order such that the first lens group is located closer to an object than the aperture stop, the second lens group, the third lens group, the fourth lens group, or the fifth lens group is,
the first lens group, the third lens group, and the fifth lens group being located at respectively fixed distances from an image plane in a direction aligned with an optical axis while the imaging optical system is focusing to make a transition from an infinity in-focus state toward a close-object in-focus state, and
the second lens group and the fourth lens group moving along the optical axis while the imaging optical system is focusing to make the transition from the infinity in-focus state toward the close-object in-focus state.

2. The imaging optical system of claim 1, wherein
the imaging optical system satisfies the following Inequality (1):
$$1. < f 1 / f < 1.5 \qquad ( 1 )$$
where f1 is a focal length of the first lens group, and
f is a focal length of the imaging optical system in the infinity in-focus state.

3. The imaging optical system of claim 1, wherein
the imaging optical system satisfies the following Inequality (2):
$$0.5 < \vert f 5 / f \vert < 1. \qquad ( 2 )$$
where f5 is a focal length of the fifth lens group, and
f is a focal length of the imaging optical system in the infinity in-focus state.

4. The imaging optical system of claim 1, wherein
the imaging optical system satisfies the following Inequality (3):
$$1.8 \leq f 2 / f 4 \leq 3.4 \qquad ( 3 )$$
where f2 is a focal length of the second lens group, and
f4 is a focal length of the fourth lens group.

5. The imaging optical system of claim 1, wherein
the fifth lens group includes a lens having negative power and located closest to the image plane, and
the imaging optical system satisfies the following Inequality (4):
$$0.1 < BF / Y < 0.5 \qquad ( 4 )$$
where BF is a distance on the optical axis from a lens surface, facing the image plane, of the lens of the fifth lens group to the image plane, and
Y is a maximum image height of the imaging optical system in the infinity in-focus state.

6. The imaging optical system of claim 1, wherein
the imaging optical system satisfies the following Inequality (5):
$$3. 0 < TL / Y < 3.8 \qquad ( 5 )$$
where TL is a total optical length of the imaging optical system in the infinity in-focus state, and
Y is a maximum image height of the imaging optical system in the infinity in-focus state.

7. The imaging optical system of claim 1, wherein
the second lens group includes a plurality of lenses,
the plurality of lenses includes:
a lens having negative power and located closest to the object in the plurality of lenses; and
a lens having positive power and located second closest to the object in the plurality of lenses, and
the imaging optical system satisfies the following Inequality (6):
$$1. 8 < n d 2 G p \qquad ( 6 )$$
where nd2Gp is a refractive index of the lens having positive power and included in the second lens group.

8. The imaging optical system of claim 1, wherein
the fourth lens group consists of a single lens, and
the imaging optical system satisfies the following Inequality (7):
$$62 < v d 4 G \qquad ( 7 )$$
where vd4G is an Abbe number of the single lens of the fourth lens group.

9. The imaging optical system of claim 1, wherein
the fifth lens group consists of a single lens, and
the imaging optical system satisfies the following Inequality (8):
$$50 < v d 5 G \qquad ( 8 )$$
where vd5G is an Abbe number of the single lens of the fifth lens group.

10. The imaging optical system of claim 1, wherein
the imaging optical system satisfies the following Inequality (9):
$$0.4 < ( 1 - β 4 \times β 4 ) \times β 4 r \times β 4 r < 1. \qquad ( 9 )$$
where β4 is a lateral magnification of the fourth lens group when the imaging optical system is in the infinity in-focus state; and
β4r is a composite lateral magnification of all lenses, located closer to the image plane than the fourth lens group is, of the imaging optical system when the imaging optical system is in the infinity in-focus state.

11. The imaging optical system of claim 1, wherein
the first lens group includes a single image blur compensation lens located closest to the image plane and configured to move perpendicularly to the optical axis, and
the imaging optical system satisfies the following Inequality (10):
$$0.2 \leq \vert ( 1 - β ) \times β r \vert \leq 1. \qquad ( 10 )$$
where β is a lateral magnification of the single image blur compensation lens when the imaging optical system is in the infinity in-focus state; and
βr is a composite lateral magnification of all lenses, located closer to the image plane than the single image blur compensation lens is, of the imaging optical system when the imaging optical system is in the infinity in-focus state.

12. The imaging optical system of claim 1, wherein
the first lens group includes a plurality of lenses,
the plurality of lenses includes:
a lens having negative power and located closest to the object in the plurality of lenses;
a lens having positive power and located second closest to the object in the plurality of lenses;
a lens having positive power and located third closest to the object in the plurality of lenses; and
a lens having negative power and located fourth closest to the object in the plurality of lenses.

13. An image capture device configured to output an optical image of an object as an electrical image signal, the image capture device comprising:
an imaging optical system configured to form the optical image of the object; and
an image sensor configured to transform the optical image formed by the imaging optical system into the electrical image signal,
the imaging optical system consisting of:
a first lens group having positive power;
an aperture stop;
a second lens group having positive power;
a third lens group having negative power;
a fourth lens group having positive power; and
a fifth lens group having negative power;
the first lens group, the aperture stop, the second lens group, the third lens group, the fourth lens group, and the fifth lens group being arranged in this order such that the first lens group is located closer to the object than the aperture stop, the second lens group, the third lens group, the fourth lens group, or the fifth lens group is,
the first lens group, the third lens group, and the fifth lens group being located at respectively fixed distances from an image plane in a direction aligned with an optical axis while the imaging optical system is focusing to make a transition from an infinity in-focus state toward a close-object in-focus state, and
the second lens group and the fourth lens group moving along the optical axis while the imaging optical system is focusing to make the transition from the infinity in-focus state toward the close-object in-focus state.
